(19) United States
(12) Patent Application Publication
(10) Pub. No.: US 2020/0178534 A1
(43) Pub. Date: Jun. 11, 2020

(54) INDUCTION OF FLORAL DEVELOPMENT IN PLANTS

(71) Applicant: ROTHAMSTED RESEARCH LIMITED, Harpenden Hertfordshire (GB)

(72) Inventor: Matthew Jeremy Paul, Harpenden Hertfordshire (GB)

(21) Appl. No.: 16/469,228

(22) PCT Filed: Dec. 12, 2017
(86) PCT No.: PCT/GB2017/053718

§ 371 Date: Jun. 13, 2019

(30) Foreign Application Priority Data
Dec. 13, 2016 (GB) 1621193.0

(51) Int. Cl. A01N 57/16

(52) U.S. Cl. CPC A01N 57/16

(57) ABSTRACT

The present invention relates to methods and uses of photo-labile compounds which are trehalose-6-phosphate or trehalose-6-phosphonate or agriculturally acceptable salts thereof in the induction of floral development in plants. The invention also concerns methods and the use of the compounds for the acceleration of floral development in treated compared with untreated plants.

### FIELD OF THE INVENTION

The present invention relates to photo-labile compounds that increase the amount or concentration of Trehalose-6-Phosphate (T6P) in plants and methods and uses of these for the induction of floral development in a wide range of plant species. The invention also concerns methods and the use of the compounds for the acceleration of floral development in treated compared with untreated plants.

### BACKGROUND

The timing of the induction of flowering determines to a large extent the reproductive success of plants. Additionally, many experimental approaches rely on the synchronisation of developmental events such as flowering. However, in ensuring a timely transition from vegetative growth to flowering, many diverse environmental and endogenous signals must be integrated by plants. Consequently, the regulation of this process at the molecular level is complex and not well understood.

The trehalose pathway has long been implicated in water stress and has previously been targeted using approaches founded on genetic modification (for example, see WO 97/42326).

WO2012/146914 ISIS Innovation Limited discloses photo-labile Trehalose-6-Phosphate and phosphonate precursors, and agriculturally acceptable salts thereof and describes methods and uses of these compounds for increasing starch production in plants.

It has been shown that the loss of TREHALOSE-6-PHOSPHATE SYNTHASE 1 (TPS1) causes Arabidopsis thaliana to flower late, even under otherwise inductive environmental conditions, suggesting that TPS1 is required for the timely initiation of flowering and that T6P forms a part of the regulatory network which regulates flowering time in Arabidopsis thaliana (Wahl et al. 2013 Science 339, 704-707).

However, understanding of the regulatory network remains incomplete and practical methods of controlling flowering are lacking.

Although genetic manipulation of plants has provided some dues, such approaches can be complicated and are not accepted in many countries (especially in Europe). There is therefore a need for a simple method of controlling flowering time in plants, which does not rely on complex genetic approaches.

The present invention is based on a surprising discovery that application of T6P precursor compounds to plants during vegetative growth phase results in the induction of floral bud development compared with non-treated control plants. Application of T6P precursor compounds to plants was also surprisingly found to accelerate floral development compared with non-treated control plants. A practical application of the discoveries on which the invention is based is an ability to chemically trigger plant flowering during vegetative growth and also to accelerate floral development.

### SUMMARY OF THE INVENTION

Accordingly, the present invention provides the use of a compound of formula (I), a phosphonate analogue thereof, or agriculturally acceptable salts thereof:

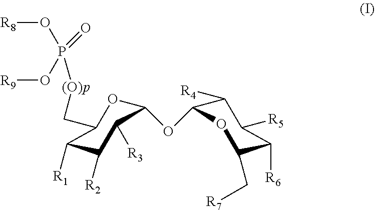

wherein;
p is 0 or 1;
R, to R₇ independently represent F, N₃, NR′R″, C₁₋₄ alkyl, —(C₁₋₄ alkyl)OH or OH, wherein R′ and R″ independently represent hydrogen or C₁₋₄ alkyl;
and R₈ and R₉ are the same or different and represent H or a photo-labile protecting group, wherein at least one of R₈ and R₉ represents a photo-labile protecting group;
for inducing flowering in a plant. The compounds defined herein are therefore used for inducing flowering in plants.

The compounds defined herein may also be used to accelerate or co-ordinate floral development in plants.

The photo-labile protecting group may be of formula (II):

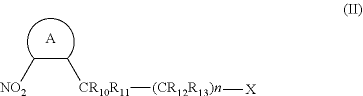

wherein;
ring A represents an aryl or heterocyclic group;
either (i) R₁₀ and R₁₁ are the same or different and are selected from hydrogen, C₁₋₄ alkyl which is unsubstituted or substituted with one or more halogen atoms, —OR′, halogen, —NR′R″ or —C0₂R′, wherein R′ and R′ are independently selected from hydrogen and C₁₋₄ alkyl, or (ii) two R₁₀ groups on adjacent photo-labile protecting groups together form a bond and R₁₁ represents hydrogen, C₁₋₄ alkyl which is unsubstituted or substituted with one or more halogen atoms, —OR′, halogen, —NR′R″ or —C0₂R′, wherein R′ and R″ are independently selected from hydrogen and C₁₋₄ alkyl;
n is 0 or 1; and R₁₂ and R₁₃ are the same or different and are selected from hydrogen, C₁₋₄ alkyl which is unsubstituted or substituted with one or more halogen atoms, —OR′, halogen, —NR′R″ or —C0₂R′, wherein R′ and R″ are independently selected from hydrogen and C₁₋₄ alkyl; wherein X represents the link to the remainder of the compound of formula (I).

The photo-labile group may be selected from;

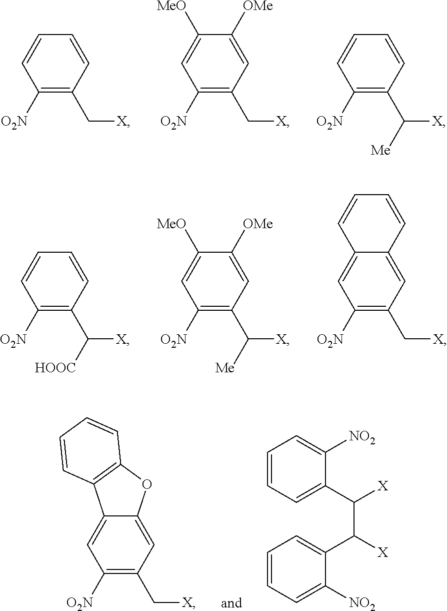

wherein X represents the link to the remainder of the compound of formula (I).

The photo-labile protecting group may be of formula (III):

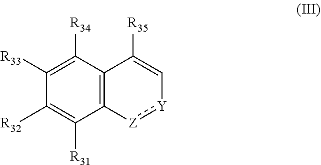

wherein;
either Z represents N, Y represents CR₃₆ and Z and Y are linked by a double bond; or Z represents O, Y represents C═O and Z and Y are linked by a single bond;
R₃₆ represents —CR₃₇R₃₈X;
when Y represents CR₃₆, R₃₅ represents hydrogen, and when Y represents C═O, R₃₅ represents —CR₃₇R₃₈X;
either (i) R₃₇ and R₃₈ are the same or different and are selected from hydrogen, C₁₋₄ alkyl which is unsubstituted or substituted with one or more halogen atoms, —OR′, halogen, —NR′R″ or —C0₂R′, wherein R′ and R″ are independently selected from hydrogen and C₁₋₄ alkyl, or (ii) two R₃₇ groups on adjacent photolabile protecting groups together form a bond and R₃₈ represents hydrogen, C₁₋₄ alkyl which is unsubstituted or substituted with one or more halogen atoms, —OR′, halogen, —NR′R″ or —C0₂R′ wherein R′ and R″ are independently selected from hydrogen and C₁₋₄ alkyl;
R₃ represents —OR′, —NR′R′, —O(C₁₋₄ alkyl)-COOR′, —O(C₁₋₄ alkyl)-OR′ or —O(C₁₋₄alkyl)-NR′R′, wherein R′ and R″ Independently represent hydrogen or C₁₋₄ alkyl; and
R₃₁, R₃₃ and R₃₄ are independently selected from hydrogen, halogen, —OR′, —NR′R″, —O(C₁₋₄ alkyl)-COOR′, —O(C₁₋₄ alkyl)-OR′ or —O(C₁₋₄ alkyl-NR′R″, wherein R′ and R″ independently represent hydrogen or C₁₋₄ alkyl;
wherein X represents the link to the remainder of the compound of formula (I).

The photo-labile protecting group may be selected from:

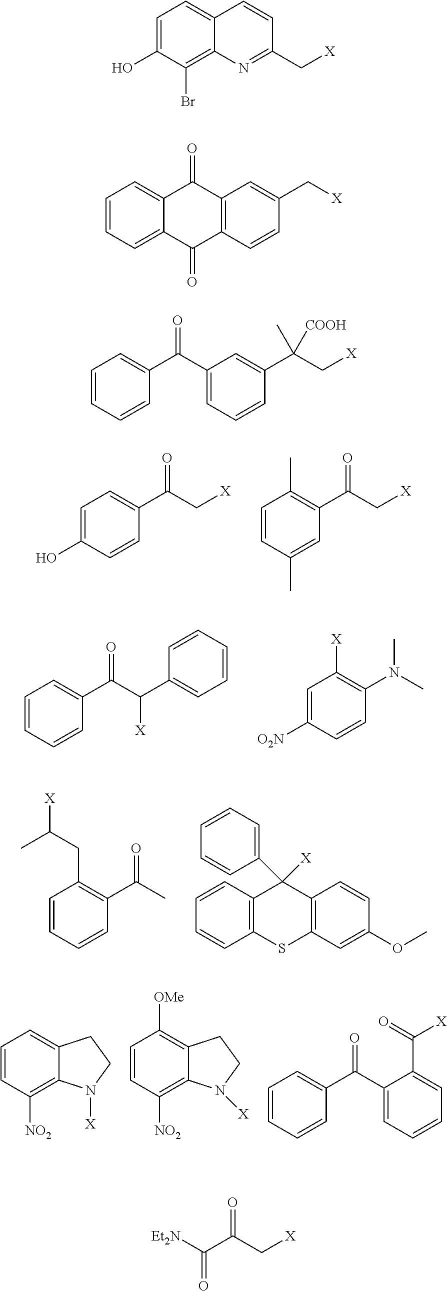

The present invention also provides the use of such a compound, wherein the photo-labile protecting group is of formula (II) and ring A represents a C₆₋₁₀ aryl group or a 5- to 14-membered heterocyclic group containing one or more atoms selected from N, O and S, wherein the aryl or heterocyclic group is unsubstituted or substituted with one or more substituents selected from C₁₋₄ alkyl, —OR′, halogen, CN, —NR′R″, —COOR′, —(C₁₋₄alkyl)COOR′ and —O(C₁₋₄alkyl)COOR′, wherein R′ and R″ are independently selected from hydrogen and C₁₋₄ alkyl, or wherein two adjacent substituents on the aryl or heterocyclic group together form a 5- or 6-membered heterocyclic ring containing one or more heteroatoms selected from N, O or S.

The photo-labile protecting group may be of formula (II) and ring A represents a phenyl, naphthalenyl or dibenzofuranyl ring.

The photo-labile protecting group may be of formula (IIa):

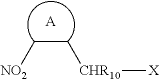

wherein;
ring A represents an unsubstituted or substituted group selected from phenyl, naphthyl or dibenzofuranyl, wherein a substituted phenyl, naphthyl or dibenzofuranyl group is a phenyl, naphthyl or dibenzofuranyl group having one or two methoxy substituents, or a phenyl, naphthyl or dibenzofuranyl group wherein two adjacent ring positions are substituted with a —CH₂—O—CH₂— moiety; and R₁₀ represents hydrogen, methyl, —CF3 or —COOH;
wherein X represents the link to the remainder of the compound of formula (I).

The photo-labile protecting group may be of formula (IIIa):

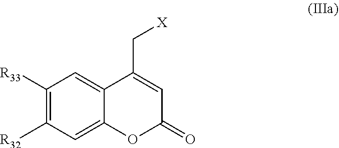

wherein;
R₃₂ represents —OR′, —NR′R″ or —O(C₁₋₄alkyl)-COOR′, wherein R′ and R″ independently represent hydrogen or C₁₋₂alkyl; and
R₃₃ represents hydrogen, Br, —OR′, —NR′R″ or —O(C₁₋₄alkyl)-COOR′, wherein R′ and R″ independently represent hydrogen or C₁₋₂ alkyl;
wherein X represents the link to the remainder of the compound of formula (I). Preferably, R₃₃ represents H and R₃₂ represents OMe, NMe₂, NEt₂ or —OCH₂COOH. Alternatively, R₃₃ may represent Br and R₃₂ may represent OH. Alternatively R₃₃ and R₃₂ may both represent —OCH₂COOH.

In accordance with the invention, R₁ to R₇ may represent hydroxyl.

In accordance with the invention, p may be 1.

Any of the compounds as described herein may be prepared in accordance with WO2012/146914 ISIS Innovations, incorporated herein by reference.

The present invention also provides a method of inducing flowering in a plant, comprising treating the plant with a compound as hereinbefore defined.

The present invention also provides a method of accelerating the floral development of a plant, wherein the method comprises treating the plant with a compound as hereinbefore defined.

In the following, the variously recited technical aspects of the methods of the invention apply equally to the claimed uses of the compounds hereinbefore defined.

In methods of the invention whether for inducing flowering in a plant or for accelerating the floral development of a plant, the methods preferably comprise treating the plant in the vegetative growth phase; in other words at any time or period prior to anthesis.

Alternatively, in methods of the invention whether for accelerating the floral development of a plant, the methods may comprise treating the plant after the onset of the reproductive phase.

The stages of plant shoot development are well characterised and morphological and anatomical traits that change in coordinated manner at predictable times in vegetative development are established for the majority of species. Vegetative growth phase or vegetative phase is therefore well known in the art and refers to the period of growth between germination and flowering, which terminates with the onset of the reproductive phase whereupon the plant acquires the capacity to produce structures required for sexual reproduction.

Most practically, this may be determined visually or alternatively relative to a characteristic profile of molecular markers defining the various phases of the plant life cycle; including for instance, but not limited to: a decrease in miR156, and miR157 expression or an increase in the expression of squamosa promoter binding protein/SBP-like (SBP/SPL) transcription factors which are known to regulate a variety of processes in shoot development, including inflorescence development and flowering time. In wheat plants for example, the vegetative phase is characterised by growth and leaf initiation and ends with spikelet initiation and floral Initiation (reviewed in Sadras and Calderini, 2015, Crop Physiology: Applications for Genetic Improvement and Agronomy, 2^{nd} Ed., Elsevier).

In methods and uses of the invention, any of the compounds may be applied alone or in conjunction with other compounds. In particular, the compounds may commonly be applied together with at least one fertilizer, fungicide, herbicide, Insecticide or plant growth regulator whether separately, sequentially or simultaneously.

Preferably, methods of the invention induce flowering in plants and/or accelerate the development of floral organs in a plant. Preferably application of any of the compounds disclosed herein results in a plant having an increased number of floral buds compared with untreated plants. Preferably application of any of the compounds disclosed herein results in a plant having a more well-developed inflorescence compared with untreated plants, i.e, a more advanced floral development. Preferably application of any of the compounds disclosed herein results in a plant having a taller inflorescence compared with untreated plants.

Accordingly, in a further aspect, the present invention provides a method of co-ordinating the floral development of plants, comprising treating the growing plants with a compound as hereinbefore defined. The plants may be treated in vegetative phase prior to flowering or alternatively post-anthesis.

In accordance with all aspects of the present invention, the compounds disclosed herein may usefully induce and/or accelerate floral development in any plant species, which may be monocots or dicots. The compounds disclosed herein may preferably be used to treat those plants which are typically exploited for grain or biomass production, exhibit high growth rates and are easily grown and harvested.

In use, the compounds disclosed herein are usually applied directly onto the surface of the plant or crop. Typically, this may be achieved by direct application to the plant or crop, for example by spraying the compound or mixture of compounds directly onto the plant material, for example onto leaves, stems or roots of the plant during vegetative phase although other equally feasible methods of application will be known in the art. It is envisaged that the compounds disclosed herein may also be applied indirectly to the medium (e.g. soil or water) in which the plants or crop are grown.

In methods of the invention aimed at accelerating the floral development of a plant, or co-ordinating the floral development of a group of plants, when floral development has already commenced, the compounds disclosed herein may be applied directly onto the surface of the floral organs (or inflorescence).

Treatment of the plants in accordance with the methods of the invention may involve a single application of the compound either to the plant or to the growth medium. However, it will be understood that treatment may alternatively involve multiple applications of the same compound or indeed combinations of the compounds disclosed herein. Where multiple (i.e. two or more) different compounds are applied to the same crop, these may be applied simultaneously, separately (in any order) or sequentially.

The compounds disclosed herein are typically provided to the plant or crop in the form of an aqueous solution. However, the compounds disclosed herein may also be provided to the plant or crop in solid form such as a powder, dust or in granular form and combinations thereof.

Where the compounds disclosed herein are provided as an aqueous solution, normally the solution applied to the plant or growth medium will have a final compound concentration in the range 0.1 to 10 mM, optionally in the range 0.1 mM to 1 M, 0.1 to 900 mM, 0.1 to 800 mM, 0.1 to 700 mM, 0.1 to 600 mM, 0.1 to 500 mM, 0.1 to 400 mM, 0.1 to 300 mM, 0.1 to 200 mM, 0.1 to 100 mM, 0.1 to 50 mM, 0.1 to 40 mM, 0.1 to 30 mM, 0.1 to 20 mM. 0.1 to 10 mM, 0.1 to 9 mM, 0.1 to 8 mM, 0.1 to 7 mM, 0.1 to 6 mM, 0.1 to 5 mM, 0.1 to 4 mM, 0.1 to 3 mM, 0.1 to 2 mM or 0.1 to 1 mM. Optionally, the compounds disclosed herein may be applied at a final concentration of 1 mM, 2 mM, 3 mM. 4 mM. 5 mM. 6 mM. 7 mM, 8 mM, 9 mM, 10 mM, 11 mM, 12 mM, 13 mM, 14 mM, 15 mM, 16 mM, 17 mM, 18 mM, 19 mM, 20 mM, 21 mM, 22 mM, 23 mM, 24 mM, 25 mM, 26 mM, 27 mM, 28 mM, 29 mM. 30 mM, 31 mM, 32 mM, 33 mM, 34 mM, 35 mM, 36 mM, 37 mM, 38 mM, 39 mM, 40 mM, 41 mM, 42 mM, 43 mM, 44 mM, 45 mM, 46 mM, 47 mM, 48 mM, 49 mM, 50 mM. 51 mM, 52 mM. 53 mM, 54 mM, 55 mM, 56 mM, 57 mM, 58 mM. 59 mM, 60 mM, 61 mM, 62 mM, 63 mM, 64 mM, 65 mM, 66 mM, 67 mM, 68 mM, 69 mM, 70 mM, 71 mM, 72 mM, 73 mM, 74 mM, 75 mM, 76 mM, 77 mM, 78 mM. 79 mM, 80 mM, 81 mM, 82 mM. 83 mM, 84 mM, 85 mM. 86 mM, 87 mM, 88 mM, 89 mM, 90 mM, 91 mM, 92 mM, 93 mM, 94 mM, 95 mM, 96 mM, 97 mM, 98 mM, 99 mM. 100 mM. Preferably, the compounds disclosed herein are applied at a final concentration of 0.1 mM, 0.2 mM, 0.3 mM, 0.4 mM, 0.5 mM, 0.6 mM. 0.7 mM, 0.8 mM, 0.9 mM, 1 mM, 1.1 mM, 1.2 mM, 1.3 mM, 1.4 mM, 1.5 mM, 1.6 mM, 1.7 mM, 1.8 mM, 1.9 mM or 2 mM. More preferably the compounds disclosed herein are applied at a final concentration of 1 mM.

The present invention provides the use of a composition comprising any of the compounds disclosed herein (and combinations thereof) or an agriculturally acceptable salt thereof in treating a plant to induce and/or accelerate flowering. Accordingly, the compounds disclosed herein and agriculturally acceptable salts thereof are preferably to be applied to the plant or growth medium as an aqueous solution.

In embodiments where the compound may be applied to plants as a powder or dust, the compounds disclosed herein may be provided alone or in combination with other compounds disclosed herein and/or together with an unreactive solid carrier and/or a surfactant, for example a wetting agent. A suitable inert solid carrier may be selected from but not limited to the group comprising days (for example attapulgite, kaolin or montmorillonite), purified or finely divided silicates and/or diatomaceous earth. Suitable surfactants may be ionic or non-ionic and have dispersing, penetrating or wetting abilities. Commonly, these surfactants may include alkylbenzenesulfonates, alkyl sulfates, sulfonated lignins, naphthalenesutfonates, condensed naphthalenesutfonates and non-ionic surfactants such as products of condensation of ethylene oxide with alkylphenols. Such surfactants may typically comprise 0.5 to 10 percent by weight of the final product for application to the plant or medium.

Solid compositions such as powders containing a compound of the invention preferably contain at least 0.1%, e.g. from 0.1 to 95% by weight of the compound of the invention and from 0.1 to 75% of an inert carrier or surfactant.

When plants are treated with any of the compounds disclosed herein by indirect application, for instance to the growth medium or soil rather than directly onto the plant surface it may be found that dusts or granular formulations are most practical. Common granular formulations may include, but are not limited to any of the compounds disclosed herein, either alone or in combination, dispersed (for instance by spraying) on an inert carrier such as coarsely ground clay.

For convenience, compounds disclosed herein may be combined with other active ingredients used for the treatment of plants, for example they may be incorporated into other agrochemical products such as fertilisers, herbicides, anti-bacterial or anti-fungal agents and/or pesticides.

Appropriate recipient plants may include grasses, trees, crops, shrubs, vegetables and ornamentals. More particularly, plants suitable for treatment with compounds disclosed herein in the present invention are those which produce a high yield of grain for food, feedstock or biomass for fuel or paper production. Examples of suitable plant types include but are not limited to fast growing crops, for example wheat, soybean, alfalfa, com, rice, maize, sorghum, panicum oat, sugar cane and sugar beet. Preferably, the plant is a cereal crop selected from the genera Tritcum, Zea, Oryza, Hordeum, Sorghum, Panicum, Avena, Saccharum or Secale. More preferably the plant is a Triticum sp. plant. Even more preferably the plant is a Triticum aestivum plant. Alternatively, a recipient plant may be a Brassica plant, preferably an Arabidopsis plant, for example an Arabidopsis thaliana plant.

Other appropriate plants may include those plants which have a high water demand and/or are used for biofuel or cellulose production, for example trees, shrubs and grasses. Preferred trees for use in the invention include poplar, hybrid poplar, willow, silver maple, sycamore, sweetgum and eucalyptus. Preferred herbaceous plants include tobacco. Perennial grasses include switchgrass (Panicum virgatum), prairie Cordgrass (Spartina sp.), reed canary grass (Phalaris arundinacea), purple false brome (Brachypodium distachyon) and Miscanthus sp.

Commonly said recipient plant may also be selected from: poplar: eucalyptus; Douglas fir: pine; walnut; ash; birch; oak; teak; spruce. Preferably said plant is used typically as a crop, whether for food or other purposes. In preferred aspects of the invention said plant may be selected from: corn (Zea mays), canola (Brassica napus, Brassica rapa ssp.), flax (Linum usitatissimum), alfalfa (Medicago sativa), rice (Oryza sativa), rye (Secale cerale), sorghum (Sorghum bicolor, Sorghum vulgare), sunflower (helianthus annuas), wheat (Tritium aestivum), soybean (Glycine max), tobacco (Nicotiana tabacum), potato (Solanum tuberosum), peanuts (Arachis hypogaea), cotton (Gossypium hirsutum), sweet potato (lopmoea batatus), cassava (Manihot esculenta), coffee (Cofea spp.), coconut (Cocos nucifera), pineapple (Anane comosus), citrus tree (Citrus spp.) cocoa (Theobroma cacao), tea (Camellia senensis), banana (Muse spp.), avocado (Persea americana), fig (Ficus casica), guava (Psidium guajava), mango (Mangifer indica), olive (Olea europaea), papaya (Carica papaya), cashew (Anacardium occidentale), macadamia (Macadamia intergrifolia), almond (Prunus amygdalus), sugar beet (Beta vulgaris), oat (Avena sp.) or barley (Hordeum vulgare).

Additionally, the compounds of the invention may be used to induce or accelerate flowering in vegetables and ornamental plants depending on the application chosen, and in particular those with commercial value, whether because they produce an edible crop (e.g. roots, tubers, stems, leaves, flowers, fruits, seeds) and/or for their aesthetic appearance (e.g. flowers, leaves, scent, fruit, stems, bark, or combination thereof). Accordingly, the recipient plant may also be selected from, for example: Parsnips, Radishes, Carrots, Beets, Daikon, Turnip, Celeriac, Rutabaga, Jicama, Asparagus, Celery, Rhubarb, Hearts of Palm, Bamboo Shoots, Broccoli, Ginger, Potato, Taro, Nopales, Rabe, Radicchlo, Turnip, Spinach, Lettuce, Cabbage, Rocket, Swiss Chard, Napa, Cabbage. Bok Choy, Kale, Collard Greens, Leek Beet Greens, Artichoke, Broccoli, Cauliflower, Calendula, Squash Blossoms, Acorn Squash, Bell Pepper, Eggplant, Cucumber, Squash, Tomato, Tomatillo, Zucchini, Sweet Corn, Chili Pepper, Melons, Orange, Tangerine, Lime, Lemon, Grapefruit, Berries, Pears, Apples, Cherries, Peaches, Sunflower Seeds, Fava beans, French beans, Runner beans, Pigeon Peas. Snow Pea, Snap Peas, Sugar Peas, Peas, Almonds, Walnuts. Pecans or Peanuts.

Examples of ornamental plants include but are not limited to; Acacia, Achillea, African Boxwood, African Lily, African Violet, Agapanthus, Ageratum, Ageratum houstonim, Alium, Alpina, Alstroemeria, Amaranthus hypochondriacus, Amaryllis, Ammi majus, Anconitum, Anemone, Anigozanthus, Annual Delphinium, Anthurium, Antirrhinum mejus, Asparagus, Aster, Aster spp., Astilbe, Azalea, Baby's Breath, Bachelor's Button, Banksia, Begonia, Bellflower; Bells of Ireland, Big Flax, Billy Buttons, Blazing Star; Bleeding Heart, Boronia, Bouvardia, Broom, Buddleia, Bupleurum, Butterfly Bush, Butterfly Orchid, California Pepperberry, Calla Lily, Campanul, Candytuft, Canterbury Bells, Carnation, Carthamus, Caspia, Cattleya, Celosia, Celosia argenta, Centaurea cyanus, Chamelaucium, Chimney Bells, Chrysanthemum, Chrysanthemum×morifolium, Clarkia, Consolide embigua, Convallaria, Coral Bell, Cordyline, Coreopsis, Comflower, Craspedla: Curly Willow, Cyclamen, Cymbidium, Cymbidium Orchid, Daffodil, Daisy, Daisy Mums, Daylily, Delphinium, Dendrobium, Dendrobium Orchid, Dianthus barbatus, Dianthus caryophyllus, Dianthus caryophyllus nana, Dragon's Tongue, Drumstick, Enthusiasm, Erica spp, Eustoma grandiflorum, False Bird of Paradise, False Spirea, Farewell-To-Spring, Flamingo Flower, Floss Flower, Freesia, Freesia×hybrida, Fuji or spider Mums, Gay Feather, Genista spp., Geranium, Gerbera, Gerbera spp., Ginger, Gladiolus, Gladiolus hybrid nanus, Goat's Beard, Godetia, Golden Rod, Guersney Lily, Gyp. Gypsophila peniculata, Heather, Helianthus annuus, Heliconia spp., Hippeastrum, Hoste, Hydrangea, Iberis amara; Impatiens, Inca Lily, Iris, Iris spp., Ivory Lily, Jade plant, Japhette Orchid, Jonquil, Kalanchoe, Kangaroo Paw, napweed, Larkspur. Lathyrus odoratus, Lavandula. Lavender, Latris, Lilac, Lilium spp., Lilly-of-the-Valley, Lily, Lily of the Field, Lily of the Nile, Limonlum, Limonium spp., Lisianthus. Lobster Claw, Love in the mist, Love-lies-bleeding, Mattholia incana, Memosa, Minature Carnation, Mini Carnation; Miniature Gladiolus, Moluccella laevis, Monkshood, Mother-in-law tongue, Musa, Myrsine, Myrtle, Myrtus, Narcissus, Nephrolepis, Nerine, Nerine Lily, Nigella; Orchid: Ornamental Onion; Omithogalum, Paeonia, Painted Tongue, Peony, Peruvian lily, Petunia, Phalaenopsis, Philodendron, Phlox. Pincushion Flower. Pitt, Pittosporum, Pixie Carnation: Pointsettia, Polianthes tuberose, Pompon Chrysanthemum, Poppy Anemone; Porium, Protea spp.; Purple Coneflower, Pussy Willow, Queen Ann's Lace, Ranunculus, Rattlesnake, Red Ribbons, Rosa spp., Rose, Rudbeckla, Safflower, Salix, Salvia, Sansevieria, Satin Flowers, Scabiosa, Schinus, Sea lavender, Sedum, Shell Flowers, Snake Plant, Snapdragon, Solidago, Solidaster spp., Speedwell, Spider Lily, Spider Mums, Spray Carnation, Star of Bethlehem, Statics, Stenamezon, Stock, Summer's Darling, Sunflower, Sweet Pea, Sweet William, Sword Fern, Syringa vulgaris, Tailflowers, Tassel flower. Thouroughwax, Throatwort, Trachelium, Tree Fern, Trumpet Lily, Tuberose, Tulip, Tulipa, Veronica, Wattle, Waxflower, Wild Plantain, Windflower, Wolfsbane, Youth and Old Age. Zentedeschia, Zinna, Zinnia elegans or Zygocactus.

In the present invention, plants, plant material or plant part may refer to leaves, stems, roots, stalks, root tips, flowers, sepals, petals, anthers, stamens, stigmas, pistils, ovaries, tissue or cells.

Plants, plant material or plant parts with “induced flowering” or accelerated flowering” may refer to plants which have a greater number of floral buds than untreated plants. Plants, plant material or plant parts with “accelerated” or “advanced” flowering may refer to plants which have more well developed floral organs (e.g. taller inflorescences) than untreated plants or plant material. Plants, plant material or plant parts with “accelerated” or “advanced” flowering may also have a greater number of floral buds than untreated plants.

### BRIEF DESCRIPTION OF THE DRAWINGS

The invention will now be described in detail with reference to Examples and with reference to the accompanying drawings, in which:

FIG. 1 shows a schematic diagram of a chemical strategy to control trehalose-6-phosphate (T6P) in plants.

FIG. 2 shows a schematic diagram illustrating the principle of photo-activated release of T6P in planta from plant permeable signalling precursors of T6P.

FIG. 3 shows the synthesis of bis-(2-nitrobenzyl)-N,N-dilsopropylphosphoramidite 9.

FIG. 4 shows the synthesis of bis-(4,5-dimethoxy-2-nitrobenzyl)-N,N dilsopropylphosphoramidite 10.

FIG. 5 shows the synthesis of bis-[1-(2-nitrophenyl)-ethyl]-N,N-diisopropylphosphoramidite 11.

FIG. 6 shows the synthesis of compound 1.

FIG. 7 shows the synthesis of compound 2.

FIG. 8 shows the synthesis of compound 3.

FIG. 9 shows the synthesis of compound 4.

FIG. 10 shows the synthesis of compound 13.

FIG. 11 shows the synthesis of compound 14.

FIG. 12 shows the synthesis of compound 15.

FIG. 13 shows the synthesis of compound 16.

FIG. 14 shows the synthesis of compound 17.

FIG. 15 shows the ¹H and ¹³C NMR Spectra of compound 9.

FIG. 16 shows the ¹H and ¹³C NMR Spectra of compound 9.

FIG. 17 shows the ¹H and ¹³C NMR Spectra of compound 10.

FIG. 18 shows the ¹H and ¹³C NMR Spectra of compound 10.

FIG. 19 shows the ¹H and ¹³C NMR Spectra of compound 11.

FIG. 20 shows the ¹H and ¹³C NMR Spectra of compound 11.

FIG. 21 shows the ¹H and ¹³C NMR Spectra of compound 1.

FIG. 22 shows the ¹H and ¹³C NMR Spectra of compound 1.

FIG. 23 shows the ¹H and ¹³C NMR Spectra of compound 2.

FIG. 24 shows the ¹H and ¹³C NMR Spectra of compound 2.

FIG. 25 shows the ¹H and ¹³C NMR Spectra of compound 3.

FIG. 26 shows the ¹H and ¹³C NMR Spectra of compound 3.

FIG. 27 shows the ¹H and ¹³C NMR Spectra of compound 4.

FIG. 28 shows the ¹H and ³C NMR Spectra of compound 4.

FIG. 29 shows the ¹H and ¹³C NMR Spectra of compound 14.

FIG. 30 shows the ¹H and ¹³C NMR Spectra of compound 14.

FIG. 31 shows the ¹H and ¹³C NMR Spectra of compound 15.

FIG. 32 shows the ¹H and ¹³C NMR Spectra of compound 15.

FIG. 33 shows the ¹H and ¹³C NMR Spectra of compound 16.

FIG. 34 shows the ¹H and ¹³C NMR Spectra of compound 16.

FIG. 35 shows the ¹H and ¹³C NMR Spectra of compound 17.

FIG. 36 shows the ¹H and ¹³C NMR Spectra of compound 17.

FIG. 37 shows the ¹H and ¹³C NMR Spectra of compound T6P.

FIG. 38 shows the ¹H and ¹³C NMR Spectra of compound T6P.

FIG. 39 shows the known biochemical structures and one-pot synthesis of designed permeable, signalling precursor variants from suitable precursors.

FIG. 40 shows the effect of spraying T6P signalling precursors on the height of the flowering inflorescence measured at 26 days after sowing (DAS). Panel A shows Col-0 plant and Panel B shows tps7 plants. Right hand bars in each panel represent plants treated with 1 mM oNPE. Left hand bars in each panel represent plants treated with water (controls). Treatment with 1 mM oNPE in Col-0 and tps7 resulted in taller inflorescences. This reflects the advancement of flowering by oNPE.

FIG. 41 shows a possible role of T6P and tps7 in control of flowering in plants and crops.

### DETAILED DESCRIPTION

### Examples

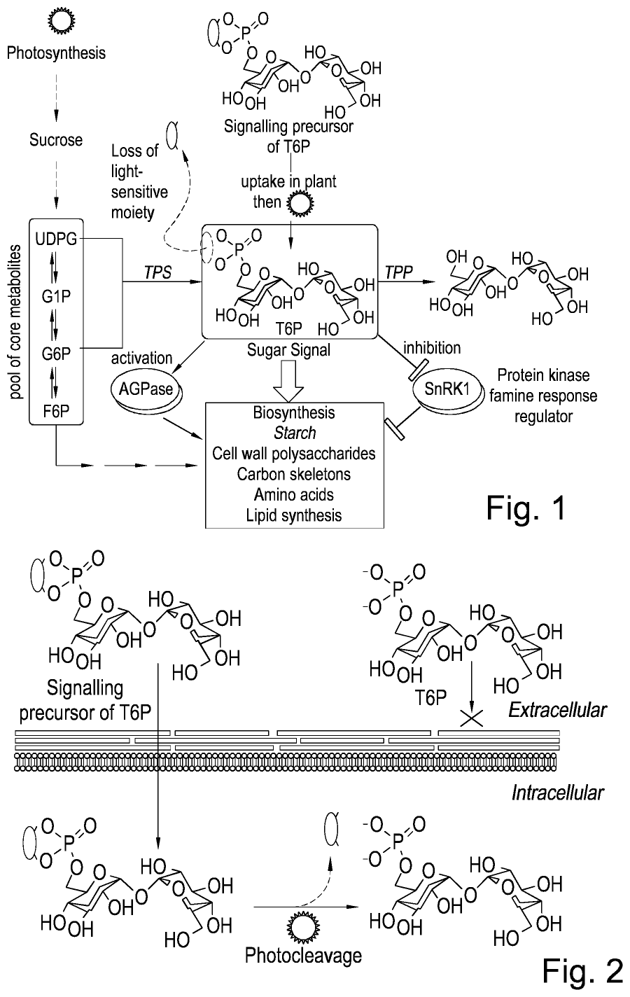

The trehalose 6-phosphate (T6P) synthesis pathway in plants is summarized in FIG. 1. Photosynthesis generates sucrose, which is translocated to growing regions of the plant. Inside the cell it feeds a pool of core metabolites which are substrates for biosynthetic processes that determine growth and productivity. T6P is synthesised from UDPG and G6P by trehalose 6-phosphate synthase (TPS) and therefore reflects the abundance of sucrose. It is broken down by trehalose phosphate phosphatase (TPP). Increasing T6P (a) stimulates starch synthesis through posttranslational redox activation of ADP-glucose pyrophosphorylase (AGPase) which catalyzes the first committed step of starch biosynthesis and (b) inhibits SnRK1, a protein kinase central to energy conservation and survival during energy deprivation. Inhibition of SnRK1 by T6P thus diverts carbon skeleton consumption into biosynthetic processes.

### Example 1. Design and Synthesis of Signalling Precursors of TSP

T6P is plant impermeable (FIG. 2). In order to alter TOP levels in planta, plant permeable signalling precursor variants were designed and synthesised in a single pot reaction starting from suitable precursors.

### Synthesis of Signalling-Precursor Compounds 1-4

1H-tetrazole solution (0.45 M in CH₃CN) (0.6 mL, 0.24 mmol, 2.0 equiv.) was added into a stirred solution of 12 (100 mg, 0.12 mmol, 1 equiv.) and bis-(2-nitrobenzyl)-N,N-diisopropylphosphoramidite 9 (78.3 mg, 0.18 mmol, 1.5 equiv.) in anhydrous CH₂Cl₂ (5 mL) under an argon atmosphere at 0° C. The resulting reaction mixture was stirred at 0-5° C., and progress of the reaction was monitored by TLC (petroleum ether ether 8:2) and mass spectrometry. After complete disappearance of starting material (1 h), tBuOOH (0.1 mL) was added at 0° C., and stirring was continued for another 30 min. After 30 min the reaction mixture was concentrated in vacuo and the residue was suspended in methanol (2 mL) and stirred in the presence of 30 mg of Dowex-H⁺ resin for 1 h at room temperature to globally remove TMS groups.

Dowex-H⁺ was removed through filtration and the filtrate was concentrated, which on flash chromatography (water:isopropanol:ethyl acetate, 1:2:8) purification yielded 1 (70 mg) in 87% isolable yield. Similar reaction protocols were adopted for the synthesis of compounds 2 and 3. Compound 4 was obtained when a stirred solution of 12 (100 mg, 0.12 mmol) in pyridine (2 mL) at room temperature was treated with POCl₃ (0.012 mL. 0.132 mmol) for 10 min followed by addition of 4,5-dimethoxy-2-nitrobenzyl alcohol (76.7 mg, 0.36 mmol) and continuous stirring for 1 h.

The resulting reaction mixture was concentrated in vacuo to yield crude product mixture, which was treated with Dowex-H⁺ (30 mg) in methanol (2 mL). After filtration, concentration in vacuo and flash chromatography purification yielded 4 (45 mg, 62%) as a pure sticky solid. Full details of the synthesis of each of the compounds are provided below.

### Synthetic Protocols, Experimental and Characterization Data for all Compounds

### Synthesis of bis-(2-nitrobenzyl)-N,N-diisopropylphosphoramidite 9

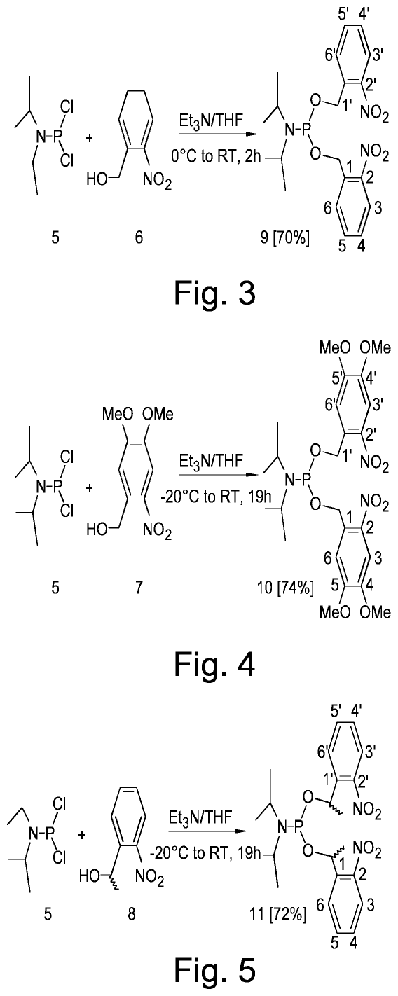

Diisopropylphosphoramidous dichloride 5 (2.0 g, 9.90 mmol) was dissolved in 15 mL of THF and the resulting solution was added slowly to a solution containing 4.2 mL (29.7 mmol) of triethylamine and 3.03 g (19.8 mmol) of 2-nitrobenzyl alcohol 6 in 10 mL of THF at 0° C. The reaction mixture was stirred at 0° C. for 30 min and then at 25° C. for another 2 h. The colorless precipitate was isolated by filtration and the solid was washed with 100 mL of ethyl acetate. The organic phase was washed successively with 15 mL portions of saturated NaHCO₃ and saturated NaCl and then dried (MgSO4) and concentrated under reduced pressure at 25° C. The residue was precipitated from ethyl acetate hexane, affording bis (2-nitrobenzyl) N,N-diisopropylphosphoramidite 9 (3.0 g, 70%) as a colorless solid.⁵ (see FIG. 3).

### bis-2-nitrobenzyl)-N,N-diisopropylphosphoramidite 9

Mp 71-72° C. [lit.⁵ Mp 71-73° C.] ¹H NMR (400 MHz, CDCl₃) δ 8.10 (d, J=8.4 Hz, 2H, H-3 and H-3′), 7.86 (d, J=8.0 Hz, 2H, H-6 and H-6′), 7.67 (t, J=8.0 Hz, 2H, H-5 and H-5′), 7.44 (t, J=8.4 Hz, 2H, H-4 and H-4′), 5.21 (dd, J=16.4 Hz and J=6.8 Hz, 2H, CH₂Ar), 5.12 (dd, J=16.4 Hz and J=6.8 Hz, 2H, CH₂Ar), 3.77-3.71 (m, 2H, 2×CH(CH₃)₂), 1.25 (d, J==8.5 Hz, 12H, 2×CH(CH₃)₂); ¹³C NMR (100 MHz, CDCl₃) δ 146.8 (C-2 and C-2′), 136.1, 136.0 (C-I and C-I′), 133.7 (C-6 and C-6′), 128.5 (C-5 and C-5′), 127.8 (C-4 and C-4′), 124.6 (C-3 and C-3′), 62.5 (CH₂Ar), 62.3 (CH₂Ar), 43.4 (CH(CH₃)₂), 43.3 (CH(CH)₂)₂), 24.7 (CH(CH₃)₂), 24.6 (CH(CH₃)₂); ³¹P NMR (162 MH, CDCl₃) δ 149.0; ESI-LRMS nm/z calculated for C₂₀H₂₆N₃O₆P [M+H]⁺ 436.1; Found 436.1.

### Synthesis of bis-(4,5-dimethoxy-2-nitrobenzyl)-N,N-diisopropylphosphoramidite 10

To a −20° C. cooled suspension of 4,5-dimethoxy-2-nitrobenzyl alcohol 7 (2.1 g, 9.90 mmol) and triethylamine (1.5 mL, 10.8 mmol) in dry THF (10 mL) was added dropwise a solution of diisopropylphosphoramidous dichloride 5 (1.0 g, 4.95 mmol) in dry THF (2 mL).

The mixture was allowed to warm to 20° C., stirred for 18 h, and a saturated solution of aq. NaHCO₃, (15 mL) added. The solid was filtered, washed with water (20 mL) and dried to give 2.0 g (74%) of 10.⁶ (see FIG. 4)

### bis-(4,5-dimethoxy-2-nitrobenzyl)-N,N-diisopropylphosphoramidite 10

¹H NMR (400 MHz, CDCl₃) δ 7.72 (s, 2H, H-3 and H-3), 7.39 (s, 2H, H-6 and H-6), 5.24 (dd, J=16.4 Hz and J=6.8 Hz, 2H, CH₂Ar), 5.15 (dd, J=16.4 Hz and J=6.8 Hz, 2H, CH₂Ar), 3.95 (s, 6H, 2×OMe), 3.94 (s, 6H, 2×OMe), 3.85-3.70 (m, 2H, 2×CH(CH₃)₂) 1.27 (d, J=8.5 Hz, 12H 2×CH(CH₃)₂); ¹³C NMR (100 MHz, CDCl₃) δ 153.8 (C-5 and C-5′), 147.5 (C-4 and C-4′), 138.6 (C-2 and C-2′), 131.7, 131.6 (C-3 and C-3), 109.2 (C-1 and C-1′), 107.8 (C-6 and C6′), 62.5 (CH₂Ar), 62.4 (CH₂Ar), 56.3 (OMe), 43.4 (CH(CH₃)), 43.3 (CH(CH₃)₂), 25.6 (CH(CH₃)₂), 24.7 (CH(CH₃)₂); ³¹NMR (162 MHz, CDCl₃) δ 147.4; ESI-LRMS m/z calculated for C₂₄H₃₄N₃O₁₀P [M+H]⁺: 556. L; Found 556.1.

### Synthesis of bis-[1-(2-nitrophenyl)-ethyl]-N,N-diisopropylphosphoramidite 11

Diisopropylphosphoramidous dichloride 5 (1.0 g, 4.95 mmol) was dissolved in 5 mL of dry THF and the resulting solution was added slowly to a solution containing 1.5 mL (10.89 mmol) of triethylamine and 1.65 g (9.90 mmol) of 1-methyl-2-nitrobenzyl alcohol 8 in 10 mL of THF at 0° C., The reaction mixture was stirred at 0° C. for 1 min and then at 25° C. for another 18 h. The reaction mixture was diluted with EtOAc. The organic phase was washed successively with 15 mL portions of saturated NaHCO₆ and saturated NaCl and then dried (MgSO4) and concentrated under reduced pressure at 25° C. to get crude product. The residue was purified by flash column chromatography using ethyl acetate/petroleum ether (5:95 v/v), affording bis-[1-(2-nitrophenyl)-ethyl]-N, N-diisopropylphosphoramidite 11 (1.6 g. 72%) as A colorless solid. (see FIG. 5)

### Bis-[1-(2-nitrophenyl)-ethyl)-N,N-diisopropylphosphoramidite 11

Isolated as a dia-stereomeric mixture. ¹H NMR (400 MHz, CDCl₃) δ 7.83-7.76 (m, 3H, H-3, H-3′ and H-5), 7.54-7.46 (m, 3H, H-5′, H-4 and H-4′), 7.33-7.18 (m, 2H, H-6 and H-6′), 5.48-5.29 (m, 2H, CH(CH₃)Ar), 3.62-3.44 (m, 2H, 2×CH(CH₃)₂), 1.55-1.48 (m, 3H, CH(CH₃)Ar), 1.40-1.35 (m, 3H, CH(CH₃)Ar), 1.13-1.07 (m, 6H, CH (CH₃)₂), 0.90-0.83 (m, 6H, CH(CH₃)₂); ¹³C NMR (100 MHz, CDCl₃) δ 147.2, 147.1, 146.9 (C-2 and C-2′), 141.3, 141.1, 140.8 (C-1 and C-1), 133.4, 133.3 (C-3 and C-3′), 128.5, 128.3 (C-5 and C-5S), 127.8, 127.7 (C-4 and C-4′), 124.0, 123.9 (C-6 and C-6′), 67.3, 67.2 (CH(CH₃)Ar), 67.0, 66.7 (CH(CH₃), 43.1, 43.0, 25.1, 25.0 (CH(CH₃)₂), 24.5, 24.4 (CH(CH₃)₂₎, 24.2, 24.1 (CH(CH₃)Ar); ESI-LRMS m/z calculated for C₂₂H₃₀N₃O₆P [M+H]⁺; 464.1; Found 464.1.

### Synthesis of Compound 1

To a solution of 12 (100 mg, 0.12 mmol. 1 equiv.) and 1H-tetrazol solution (16.8 mg, 0.24 mmol, 2.0 equiv, ˜0.5 mL of 0.4M solution in CH₃CN) in anhydrous CH₂Cl₂ (4 mL) under an argon atmosphere at 0° C. m bis-(2-nitrobenzyl)N-diisopropylphosphoramidite 9 (78.3 mg. 0.18 mmol, 1.5 equiv.) was added. The solution was stirred for 30 min and progress of the reaction was monitored by TLC (petroleum ether:ether; 8:2). After complete disappearance of starting material, tBuOOH (32.5 mg, 0.36 mmol, 3.0 equiv˜0.1 mL of 5M solution in decane) was added at 0° C., and stirred for 30 min. After 30 min the reaction mixture was concentrated in vacuo and the residue was stirred with 30 mg of Dowex-H⁺ resin in methanol (10 mL) for 1 h to obtain deprotected compound as a crude product. This crude product after flash chromatography purification yielded desired

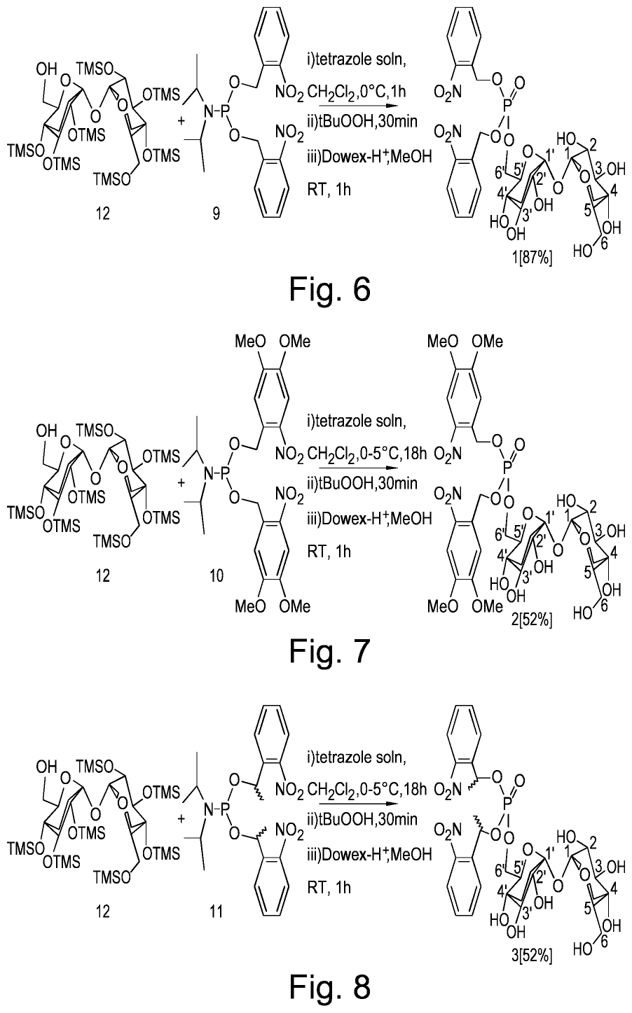

product 1 (70 mg) in 87% isolable yield. (see FIG. 6)

### 6-O-bis-(2-nitrobenzyloxyphosphoryl)-D-trehalose 1

R_{f}0.60 (1 water; 2 isopropanol: 4 ethyl acetate). [α]_{D}²¹+80.6 (c1.0, MeOH); FT-IR (ATR) v cm⁻¹ (3347 (br, OH), 1526 (s, N═O), 1343 (s, N═O), 1255 (P═O); ¹H NMR (500 MHz, D₂O) δ 8.02 (d, J=8.0 Hz, 2H ArH), 7.66-7.65 (m, 4H, ArH), 7.50-7.46 (m, 2H, ArH), 5.43 (d, J=7.2 Hz, 4H, 2×(CH₂Ar), 4.96 (d, J_{r,z}=3.6 Hz, 1H, H-1′), 4.93 (d, J_{1,2}=3.6 Hz, 1H, H-1), 4.40 (dd, J_{6′a,6′b}=11.0 Hz, J_{6′a,5}=2.0 Hz, 1H, H-6′a), 4.35 (dd, J_{6′n,6′a}=11.0 Hz, J_{6′b,5}=4.5 Hz, 1H, H-6′b), 3.93 (td, J_{5′4′}=10.0 Hz and J_{5′,6′a}=2.0 Hz, 1H, H-5), 3.71 (t, J_{3′2′}=9.2 Hz, J_{3′,4′}=9.2 Hz, 1H, H-3′, 3.70-3.68 (m, 1H, H-5), 3.67 (t, J_{3,2}=9.6 Hz, J_{3,4}=9.6 Hz 1H, H-3), 3.66-3.65 (m, 1H, H-6a), 3.58 (dd, J_{6b,6a}=12.0 Hz and J_{6b,5}=5.2 Hz, 1H, H-6b), 3.44 (dd, J_{2′3′}=9.9 Hz, J_{2′,1′}=3.5 Hz, 1H, H-2′), 3.40 (dd, J_{2,3}=9.6 Hz, J_{2,1}=3.8 Hz, 1H, H-2), 3.27 (t, J_{4′3′}=9.6 Hz, J_{4′5′}=9.6 Hz, 1H, H-4′), 3.22 (t, J_{4,3}=9.6 Hz J_{4,5}9.6 Hz, 1H, H-4); ¹³C NMR (125 MHz, D20) δ 147.7 (qCAr), 134.3 (qCAr), 132.1 (ArC), 132.0 (ArC), 129.4 (ArC), 129.0 (ArC), 128.9 (ArC), 125.0 (ArC), 94.4 (C-1′), 94.3 (C-1), 73.5 (C-3), 73.3 (C-3), 72.8 (C-2), 72.1 (C-2), 72.0 (C-5), 71.0 (C-5), 70.9 (C-4), 70.8 (C-4), 70.1 (C-6′), 67.2 (CH₂Ar), 66.6 ((H₁₂Ar), 61.6 (C-6); ³¹P NMR (162 MHz, D₂O) δ −0.11; ESI-HRMS m/z calculated for C₂₆H₃₃N₂O_{1K}P [M+Na]⁺ 715.1368; Found 715.1368.

### Synthesis of Compound 2

To a solution of 12 (100 mg. 0.12 mmol, 1 equiv.) and 1H-tetrazol (84 mg. 1.2 mmol, 10 equiv. 3.0 mL of 0.4 M solution in CH₃CN) in anhydrous CH₂Cl₂ (8 mL) under an argon atmosphere at 0° C., bis-(4,5-dimethoxy-2-nitrobenzyl)-N,N-diisopropylphosphoramidite 10 (100 mg, 0.18 mmol, 1.5 equiv.) was added and the resulting reaction mixture was stirred at 0-5° C. The progress of the reaction was monitored by TLC (petroleum ether:ether, 8:2). After complete disappearance of starting material (18 h), tBuOOH (32.5 mg, 0.36 mmol, 3.0 equiv.˜0.1 mL of 5M solution in decane) was added at 0° C. and the mixture stirred for a further 30 min. After 30 min the reaction mixture was concentrated in vacuo and the residue was stirred with 30 mg of Dowex-H⁺ resin in methanol (10 mL) for 1 h to obtain deprotected compound as crude product. This crude product after flash chromatography purification yielded desired product 2 (50 mg) in 52% isolable yield. (see FIG. 7)

### 6-O-bis-(4,5-dimethoxy-2-nitrobenzyloxyphosphoryl)-D-trehalose 2

R_{f} 0.50 (1 water; 2 isopropanol: 4 ethyl acetate); [α]_{D}²¹+64.8 (c1.1, MeOH); FT-IR (ATR) v cm⁻¹ 3347 (br, OH), 1519 (s, N═O), 1326 (s, N═O), 1220 (P=O): ¹H NMR (500 MHz, CD₃OD) δ 7.53 (s, 2H, ArH), 7.03 (s, 2H, ArH), 5.37 (d, J=8.0 Hz, 4H, 2×CH2Ar), 4.95 (d, J_{1′2′}=4.0 Hz, 1H, H-1′), 4.91 (d, J_{1,2}=4.0 Hz, 1H, H-1), 4.30 (dd, J_{6′a,6′b}=11.6 Hz, J_{6′a,6′a}=2.0 Hz, 1H, H-6′a), 4.35 (dd, J_{6′b,6′a}=11.0 Hz, J_{6′b,5}=3.6 Hz, 1H, H-6′b), 3.94 (td, J_{5′,4′}=10.0 Hz and J_{5′,6′a}=2.0 Hz, 1H, H-5′), 3.71 (t, J_{3′2′}=9.6 Hz, J_{3′,4′}=9.6 Hz, 1H, H-3′), 3.70-3.68 (m, 1H, H-5), 3.67 (t, J_{3,2}=9.6 Hz, J_{3,4}=9.6 Hz, 1H, H-3), 3.66-3.65 (m, 1H, H-6a), 3.58 (dd, J_{6b,6a}=11.6 Hz and J_{6b,5}=5.6 Hz, 1H, H-6b), 3.35 (dd, J_{3′,3′}=8.4 Hz, J_{2′,′}=4.0 Hz, 1H, H-2′), 3.33 (dd, J_{2,3}=8.5 Hz, J_{2,1}=3.8 Hz, 1H, H-2), 3.26 [t, J_{4′,5′}=8.8 Hz, J_{4′5′}=8.8 Hz, 1H, H-4′), 3.24 (t, J_{4,3}=9.6 Hz, J_{4,5}=9.6 Hz, 1H, H-4); ¹³C NMR (125 MHz, CD₃OD) δ 154.2 (qCAr), 148.9. (qCAr),143.7 (qCAr), 139.6 (ArC), 126.8 (ArqC), 126.6 (ArC), 10.4 (ArC), 110.3 (ArC), 108.2, 94.4 (C-1′), 94.3 (C-1), 73.5 (C-3′), 73.3 (C-3), 72.8 (C-2′), 72.1 (C-2), 72.0 (C-5′), 70.8 (C-5), 70.2 (C-6), 69.7 (CH₂Ar), 66.6 (CH₂Ar), 61.6 (C-6), 56.1 (2×OMe), 55.8 (2×OMe); ³¹P NMR (162 MHz CD₃OD) δ −0.15; ESI-HRMS m/z calculated for C₃₀H₄₁N₂O₂₂P [M+Na]⁺; 835.1786; Found 835.1782.

### Synthesis of Compound 3

To a solution of 12 (100 mg, 0.12 mmol, 1 equiv.) and 1H-tetrazol (84 mg, 1.2 mmol, 10 equiv. 3.0 mL of 0.4 M solution in CH₃CN) in anhydrous CH₂Cl₂ (8 mL) under an argon atmosphere at ° C., his-[i-(2-nitrophenyl)-ethyl]-N,N-diisopropylphosphoramidite 11 (83.5 mg, 0.18 mmol, 1.5 equiv.) was added and the resulting reaction mixture was stirred at 0-5° C. The progress of the reaction was monitored by TLC (petroleum ether:ether, 8:2) and mass spectrometry. After complete disappearance or starting material (18 h), tBuOOH (32.5 mg. 0.36 mmol, 3.0 equiv.˜0.1 mL of 5M solution in decane) was added at 0° C., and stirred for 30 min. After 30 min the reaction mixture was concentrated in vacuo and the residue was stirred with 30 mg of Dowex-H⁺ resin in methanol (10 mL) for 1 h to obtain deprotected compound as crude product. This crude product after flash chromatography purification yielded desired product 3 (44 mg) in 52% isolable yield. (see FIG. 8)

### 6-O-bis[1-(2-nitrophenyl)-ethoxyphosphoryl]-D-trehalose 3

Isolated as mixture of four diastereomers. R_{f}0.65 (1 water:2 isopropanol:4 ethyl acetate); FT-IR (ATR) v cm⁻¹ 3394 (br, OH), 1521 (s, N═O), 1326 (s, N═O), 1276 (P=O); ¹H NMR (500 MHz, CD₃OD) δ 7.91-7.05 (m, 8H, ArH), 5.92-5.84 (m, 2H, 2×CHMe), 5.04-4.94 (m, 2H, H-1 and H-1′), 3.90-3.60 (m, 7H), 3.41-3.05 (m, 5H), 1.56-1.46 (m, 6H, 2×CHMe); ¹³C NMR (125 MHz, CD₃OD δ 148.8, 148.3, 148.2 148.1 (qCAr), 147.9, 145.4, 138.9, 138.3 (qCAr), 138.2, 135.4, 135.3, 135.2 (ArC), 130.4, 130.3, 129.9, 129.3, 129.2, 128.8 (ArC) 128.7, 128.6, 126.3, 125.6, 125.5 (ArC), 95.4 (C-1′), 95.3 (C-1), 79.8, 74.6 (C-3′), 74.4, 74.2, (C-3), 74.0, 73.9 (C-2′), 73.6, 73.3 (C-2), 73.2, 73.1 (C-5′), 73.0, 72.9 (C-5), 71.9, 71.8 (C-4′), 71.2, 71.1 (C-4), 71.0 (C-6′), 68.5, 68.4 (CHMe₂), 68.2, 68.1 (CHMe₂), 62.6, 62.1 (C-6), 30.7, 30.5, 24.7 (CHCH₃), 24.6, 23.5, 23.7 (CHCH₃); ³¹P NMR (162 MHz, CD₃OD) δ−1.70, −2.20, −2.50, −2.81 (P=O) four peaks from different diastereometers; ESI-HRMS m/z calculated for C₂₈H₃₇N₂O₁₈P [M+Na]⁺; 743.1677; Found 743.1676.

### Synthesis of Compound 4

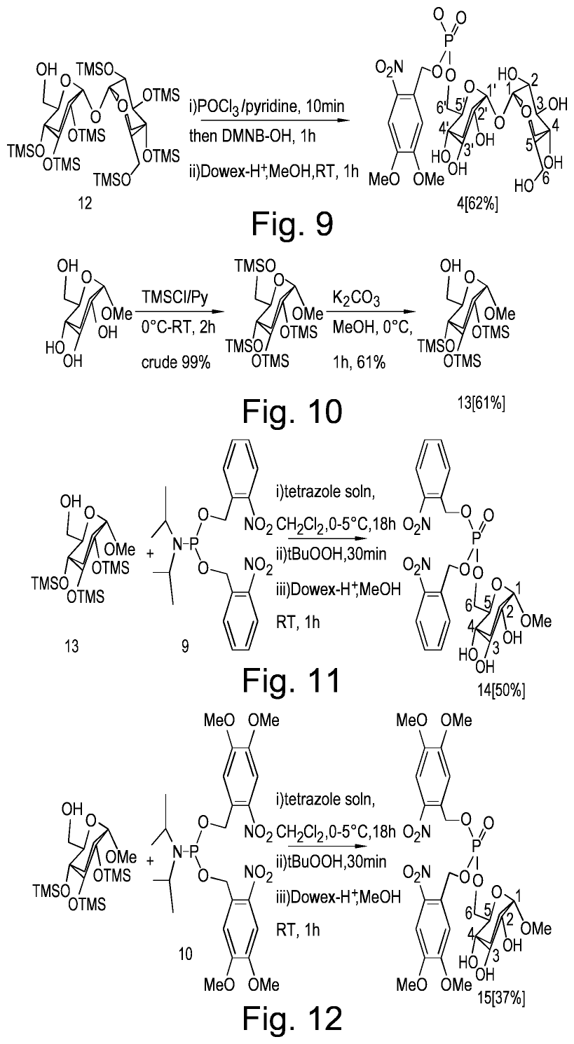

To a stirred solution of compound 12 (100 mg, 0.12 mmol) in pyridine (2 mL) at room temperature, POCl₃ (0.012 mL, 0.132 mmol) was added dropwise and the mixture was stirred for a further 10 min. After 10 min 4,5-dimethoxy-2-nitrobenzyl alcohol (DMNB-OH) (76.7 mg, 0.36 mmol) was added and the reaction mixture stirred for further 1 h. The reaction mixture was concentrated in vacuo to get crude product mixture, which after treatment with Dowex-H⁺ (50 mg) in methanol (2 mL) furnished compound 2 and 4. After filtration, concentration in vacuo and flash chromatography purification yielded 4 (45 mg, 62%) as a gum. (see FIG. 9)

### 6-O-(4,5-dimethoxy-2-nitrobenzyloxyphosphoryl)-trehalose 4

R_{f} 0.33 (1 water:2 isopropanol:4 ethyl acetate); [α]_{D}²¹+48.7 (c1.1, MeOH); FT-IR (ATR) v cm⁻¹ 3312 (br, OH), 1521 (s, N═O), 1326 (s, N═O), 1220 (P=O); ¹H NMR (500 MHz, CD₃OD) δ 7.62 (s, 1H, ArH), 7.39 (s, 1H, ArH), 5.21 (d, J=6.0 Hz, 2H, CH₂A), 4.91 (d, J_{1′,2′}=4.0 Hz, 1H, H-1′), 4.87 (d, J_{1,2}=4.0 Hz, 1H, H-1), 4.14-3.98 (m, 2H, H-6′), 3.88 (s, 3H, OMe), 3.80 (s, 3H, OMe), 3.71-3.65 (m, 4H, H-6a, H-3′, H-3 and H-5′), 3.57 (dd, J_{6b,6a}=12.0 Hz and J_{6b,5}=5.6 Hz, 1H, H-6b), 3.35 (dd, J_{2′,3′}=7.2 Hz and J_{2′,1′}=3.6 Hz, 1H, H-2′), 3.32 (dd, J_{2.3}=6.8 Hz and J_{2,1}=3.4 Hz, 1H, H-2), 3.22-3.21 (m, 3H, H-4′, H-4 and H-5); ¹³C NMR (125 MHz, CD₃OD) δ 155.5 (qC Ar), 149.0 (qC Ar) 139.9 (qC Ar), 132.1 (qC Ar), 110.8 (ArC), 109.0 (ArC), 95.3 (C-1′), 95.2 (C-1), 74.4 (C-3′), 74.3 (C-3), 73.7 (C-2′), 73.2 (C-2), 73.1 (C-5′), 72.7 (C-5), 71.8 (C-4′), 71.4 (C-4), 65.9 (CH₂Ar), 65.5 (C-6′), 62.6 (C-6), 57.0 (OMe), 56.8 (OMe); ³¹P NMR (162 MHz, CD₃OD) δ 2.18 (P=O): ESI-HRMS m/z calculated for C₂₁H₃₂NO₁₈P [M−H]⁻: 616.1279; Found 616.1273.

### Synthesis of Compound 13

Methyl tetra-O-trimethylsiyl-α-D-glucopyranoside (3.0 gm, 4.14 mmol, 1 equiv.) was dissolved in methanol (50 mL) and kept at 0° C. followed by the addition of K₂CO₃ solution in MeOH (50 mL, 4.5 g/L) at 0-4° C., and stirred for 1 h (TLC, EtOAc:petroleum ether, 1:4). After neutralization with AcOH (5 mL), the mixture was concentrated to yield crude product mixture. The crude product mixture was dissolved in dichloromethane (50 mL) and washed with water (3×15 mL). The dichloromethane layer was separated and concentrated in vacuo. Flash chromatography (EtOAc:petroleum ether; 1:9) yielded desired product 13 (1.56 g, 61%).² (see FIG. 10)

### Methyl 2,3,4-tri-O-trimethylsilyl-α-D-glucopyranoside 13

colourless solid [α]_{D}²¹+95.3 (c 1, CHCl₃), [lit₂ [α]_{D}²¹+93 (c3, CHCl₃)]; ¹H NMR (400 MHz, CDCl₃): δ 4.61 (d, J_{1,2}=3.6 Hz, 1H, H-1), 3.78-3.74 (m, 2H, H-6′ and H-3), 3.68 (dd, J_{6,5}=4.4 Hz J_{6,6′}=11.6 Hz, 1H, H-6), 3.57 (ddd, J_{5,4}=9.6 Hz, J_{5,6}=4.3 Hz, J_{5′,6′}=3.1 Hz, 1H, H-5), 3.48 (dd, J_{2,1}=3.0 Hz, J_{2,3}=8.4 Hz, 1H, H-2), 3.45 (dd, J=6.4 Hz, J=2.4 Hz, 1H, H-4), 3.34 (s, 3H, OMe), 0.17 (s, 9H, Si(CH₃)₃), 0.15 (s, 9H, Si(CH₃)₃), 0.14 (s, 9H, Si(CH₃)₃); ¹³C NMR (100 MHz, CDCl₃); δ 99.6 (C-1), 74.8 (C-3), 73.7 (C-2), 71.9 (C-4), 71.5 (C-5), 61.8 (C6), 54.8 (OMe), 1.2 (s, 3C, Si(CH₃)₃), 0.86 (s, 3C, Si(CH₃)₃), 0.46 (s, 3C, Si(CH₃)₃); ESI-LRMS m/z calculated for C₁₆H₃₆O₆Si₃ [M+Na]⁺: 433.18; Found 433.20.

### Synthesis of Compound 14

To a solution of 13 (100 mg, 0.24 mmol, 1 equiv.) and 1H-tetrazol (85 mg, 1.21 mmol, 5.0 equiv. 3.0 mL of 0.4M soln in CH₃CN) in dry CH₂Cl₂ (8 mL) under an argon atmosphere at 0° C., bis-(2-nitrobenzyl)-N,N-diisopropylphosphoramidite 9 (156 mg, 0.36 mmol, 1.5 equiv.) was added. The solution was stirred overnight at 0-5° C. After complete disappearance of starting material (18 h), tBuOOH (64.8 mg, 0.72 mmol, 3.0 equiv.˜0.2 ml of 5.0 M soln in decane) was added at 0° C. After 30 min of stirring the mixture was concentrated to dryness. The residue was dissolved in methanol (15 mL) and stirred with 30 mg of Dowex-H⁺ resin for 1 h to obtain deprotected compound. After 1 h the mixture was filtered and the filtrate was concentrated to yield deprotected crude product which on flash chromatography purification yielded desired product 14 (66 mg) in 50% Isolable yield. (see FIG. 11)

### Methyl 6-O-bis(2-nitrobenzyloxyphosphoryl)-α-D-glucopyranoside 14

R_{f} 0.50 (1 Methanol: 9 dichloromethane): [α]_{D}²¹+49.5 (c1.0, MeOH); FT-IR (ATR) v cm⁻¹ 3354 (br, OH), 1525 (s, N═O), 1342 (s, N═O), 1255 (P=O); ¹H NMR (400 MHz, CD₃OD): δ 8.00 (d, J=8.0 Hz, 2H, ArH), 7.67-7.61 (m, 4H, ArH), 7.48 (t, J=8.0 Hz, 1H, ArH), 7.47 (t, J=8.0 Hz, 1H, ArH), 5.44 (d, J=7.2 Hz, 4H, 2×CH2Ar), 4.50 (d, J_{1,2}=3.6 Hz, 1H, H-1), 4.31 (ddd, J_{6a,6b}=11.2 Hz, J_{6a,31P}=6.4 Hz, J_{6a,5}=1.6 Hz, 1H, H-6a), 4.22 (ddd, J_{6a,6b}=12.0 Hz, J_{6b,31P}=7.2 Hz, J_{6b,5}=4.8 Hz, 1H, H-6b), 3.57 (ddd, J_{5,4}=10.0 Hz, J_{5,6}=4.8 Hz, J_{5,6′}=1.6 Hz, 1H, H-5) 3.50 (brt, J_{3,2}=9.2 Hz J_{3,4}=9.2 Hz, 1H, H-3), 3.24 (dd, J_{2,1}=3.6 Hz, J_{2,3}=9.2 Hz, 1H, H-2), 3.23 (s, 3H, OMe), 3.20 (dd, J_{4,3}=9.2 Hz, J_{4,5}=9.7 Hz, 1H, H-4); 13C NMR (400 MHz, CD₃OD): δ 147.3 (qC Ar), 143.3 (qC Ar), 134.2, 132.0, 129.4, 128.8, 125.0 (ArC), 100.3 (C-1), 73.9 (C-3), 72.3 (C-2), 70.7 (C5), 70.1 (C-4), 67.9 (C-6), 66.5 (CH₂Ar),

54.7 (OMe); ³¹P NMR (162 MHz, CD₃OD) δ −1.65; ESI-HRMS m/z calculated for C₂₁H₂₅N₂O₁₃P [M+Na]⁺: 567.0986; Found 567.0983.

### Synthesis of Compound 15

To a solution of 13 (100 mg, 0.24 mmol. 1 equiv.) and 1H-tetrazol (85 mg, 1.21 mmol, 5.0 equiv, 3.0 mL of 0.4M soln in CH₃CN) in dry CH₂Cl₂ (8 mL) under an argon atmosphere at 0′C, bis-(4,5-dimethoxy-2-nitrobenzyl)-N,N-diisopropylphosphoramidite 10 (200 mg, 0.36 mmol, 1.5 equiv.) was added. The solution was stirred overnight at 0-4° C. After complete disappearance of starting material (18 h), tBuOOH (64.8 mg, 0.72 mmol, 3.0 equiv.˜0.2 mL of 5.0 M soln in decane) was added at 0° C. After 30 min of stirring the mixture was concentrated to dryness. The residue was dissolved in methanol (15 mL) and stirred with 30 mg of Dowex-H⁺ resin for 1 h to obtain deprotected compounds. After 1 h the mixture was filtered and the filtrate was concentrated to yield fully deprotected crude product which on flash chromatography yielded desired product 15 (60 mg) in 37% isolable yield. (see FIG. 12)

### Methyl 6-O-bis-(4,5-dimethoxy-2-nitrobenzyloxyphosphoryl-α-D-glucopyranoside 15

R_{f}0.40 (1 Methanol: 9 dichloromethane); [α]_{D}²¹+40.7 (c1.09, MeOH); FT-IR (ATR) v cm⁻¹3355 (br, OH), 1519 (s, N═O), 1326 (s, N═O), 1220 (P=O); ¹H NMR (400 MHz, CD₃OD): δ 7.51 (s, 2H, ArH), 7.03 (s, 2H, ArH), 5.37 (d, J=8.0 Hz, 4H, 2×CH₂Ar), 4.50 (d, J_{1,2}=3.6 Hz, 1H, H-1), 4.32 (ddd, J_{6a,6b}=11.2 Hz, J_{6a,31P}=6.4 Hz, J_{6a,5}=1.6 Hz, 1H, H-6a), 4.22 (ddd, J_{6b,6a}=12.0 Hz, J_{6b,31P}=7.2 Hz, J_{5,6b}=4.8 Hz, 1H, H-6b), 3.80 (s, 3H, OMe), 3.78 (s, 3H, OMe), 3.57 (dd, J_{5,4}=10.0 Hz, J_{5,6b}=4.8 Hz, 1H, H-5), 3.50 (brt, J_{3,2}=9.2 Hz, J_{3,4}=9.2 Hz, 1H, H-3), 3.25 (dd, J_{2,1}=3.6 Hz, J_{2,3=9.2} Hz, 1H, H-2), 3.24 (s, 3H, OMe), 3.21-3.16 (m, 1H, H-4); ¹³C NMR (400 MHz, CD₃OD): δ 154.1, 148.9 (qC Ar), 143.2, 139.5 (qC Ar), 126.6 110.3, 108.1 (ArC), 100.3 (C-1), 73.9 (C-3), 72.3 (C-2), 70.7 (C-5), 70.1 (C-4), 68.0 (C-6), 66.8 (CH₂AR), 56.0, 55.8 (OMe), 54.7 (OMe); ³¹P NMR (162 MHz, CD₃OD) δ −1.62; ESI-HRMS m/z calculated for C2H₃₃N₂O₁₇P [M+Na]⁺: 687.1409; Found 687, 1421.

### Synthesis of Compound 16

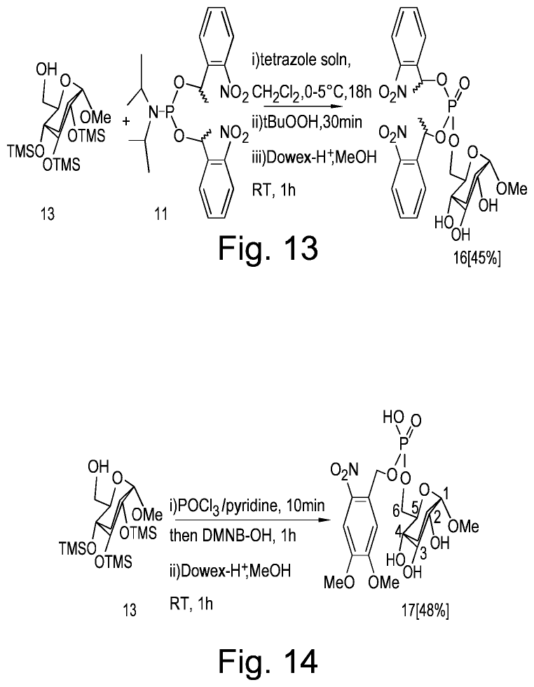

To a solution of 13 (100 mg, 0.24 mmol, 1 equiv.) and 1H-tetrazol (85 mg. 1.21 mmol, 5.0 equiv, 3.0 mL of 0.4M soln in CH₃CN) in dry CH2Cl₂ (5 mL) under an argon atmosphere at 0° C., bis-[1-(2-nitrophenyl)-ethyl]-N,N-diisopropylphosphoramidite 11 (167 mg, 0.36 mmol, 1.5 equiv.) was added. The solution was stirred overnight (15 h) at 0-4° C. After complete disappearance of starting material, t-BuOOH (64.8 mg, 0.72 mmol, 3.0 equiv˜0.2 ml of 5.0 M soln in decane) was added at 0° C. After 30 min of stirring the mixture was concentrated in vacuo. The residual mixture was deprotected by stirring in methanol (15 mL) with 25 mg of Dowex-H⁺ resin for 1 h. After filtration the filtrate was concentrated to yield fully deprotected crude product which on flash chromatography purification yielded desired product 16 (62 mg) in 45% yield. (see FIG. 13)

### Methyl 6-O-bis[1-(2-nitrophenyl)-ethoxyphosphoryl]-α-D-glucopyranoside 16

R_{f} 0.55 (1 Methanol:9 dichloromethane); Isolated as a mixture of four diastereomers, FT-IR (ATR) v 3334 cm⁻¹ (br, OH), 1520 (s, N═O), 1325 (s, N═O), 1219 (P=O); ¹H NMR (400 MHz, CD₃OD); δ 7.86-7.84 (m, 2H, ArH), 7.75-7.50 (m, 3H, ArH), 7.45-7.34 (m, 3H, ArH), 5.89-5.80 (m, 2H, 2×CH(CH₃), 4.57-4.45 (4d, J₁=3.6 Hz, 1H, H-1), 4.16-3.89 (m, 2H, H-6). 3.51-3.40 (m, 2H, H-5 and H-3), 3.31-3.25 (m, 1H, H-2), 3.25, 3.22 3.17, 3.13 (4s, 3H, OMe), 3.16-3.12 (m, 1H, H-4), 1.68-1.57 (4d, J=6.8 Hz, 6H, 2×CH(CH₃): ¹³C NMR (400 MHz, CD₃OD): δ 137.2, 137.2, 134.3, 134.2, 129.4, 129.3, 127.8, 127.7, 127.6, 127.5, 124.6, 124.5 (ArC), 100.7, 100.3, 100.2, 100.1 (C-1), 74.0, 73.9 (C-3), 73.3, 73.2 (C-2), 72.9, 72.3 (C-5), 72.2, 70.6 (C-4), 70.5, 70.1 (C-6), 70.0, 67.4 (CH(CH₃)), 55.1, 54.8, 54.7, 54.6 (OMe), 23.6, 23.5, 23.4 (CH(CH₃)); ³¹P NMR (162 MHz, CD₃OD) δ −3.2, −3.7, −3.8, −4.0; ESI-HRMS m/z calculated for C₂₃H₂₉N₂O₁₃P [M+Na]⁺: 595.1299; Found 595.1305.

### Synthesis of Compound 17

To a stirred solution of compound 13 (100 mg, 0.24 mmol) in pyridine (2 mL) at room temperature POCl₃ (0.024 mL. 0.26 mmol) was added and the mixture stirred. After 10 min, 4,5-dimethoxy-2-nitrobenzyl alcohol (153.4 mg, 0.72 mmol) was added and the reaction mixture was left stirring at the same temperature for 1 h. The reaction mixture was then concentrated in vacuo to yield crude product mixture, which after treatment with Dowex-H⁺ resin (50 mg) in methanol (2 mL) furnished compound 15 and 17. Filtration, concentration in vacuo and flash chromatography purification yielded compound 17 (55 mg. 48%) as a pure solid. (see FIG. 14)

### Methyl 6-O-(4,5-dimethoxy-2-nitrobenzyloxyphosphoryl)-α-D-glucopyranoside 17

R_{f} 0.35 (1 water: 2 isopropanol: 4 ethyl acetate): [α]_{D}²¹+38.9 (c0.64. MeOH), FT-IR (ATR) v cm⁻¹ 3319 (br OH), 1521 (s, N═O), 1326 (s, N═O), 1220 (P=O); ¹H NMR (400 MHz, CD₃OD): δ 7.74 (s, 1H, ArH), 7.50 (s, 1H, ArH), 5.33 (d, J=6.4 Hz, 2H, CH₂Ar), 4.57 (d, J_{1,2=3.6} Hz, 1H, H-1), 4.02 (s, 3H, OMe), 3.92 (s, 3H, OMe), 3.64-3.60 (m, 2H, H-6), 3.42 (dd, J_{5,4}=9.6 Hz, J_{5,6b}=2.8 Hz, 1H, H-5), 3.40 (brt, J_{3,2}=9.2 Hz, J_{3,4}=9.2 Hz, 1H, H-3), 3.39 (dd, J_{2,3}=9.6 Hz, J_{2,1}=3.0 Hz, 1H, H-2), 3.32 (s, 3H, OMe), 3.32-3.31 (m, 1H, H-4); ¹³C NMR (400 MHz, CD₃OD): δ 154.3, 147.9, 138.9, 131.1, 110.0, 107.9 (ArC), 100.0 (C-1), 73.6 (C-3). 72.2 (C-2), 71.3 (C-5), 70.0 (C-4), 64.8 (C-6), 64.5 (CH₂Ar), 56.3 (OMe), 56.0 (OMe), 54.8 (OMe); ³¹P NMR (162 MHz, CD₃OD) δ 0.66; ESI-HRMS m/z calculated for C₁₆H₂₄NO₃₃P [M−H]⁻: 468.0907; Found 468.0905.

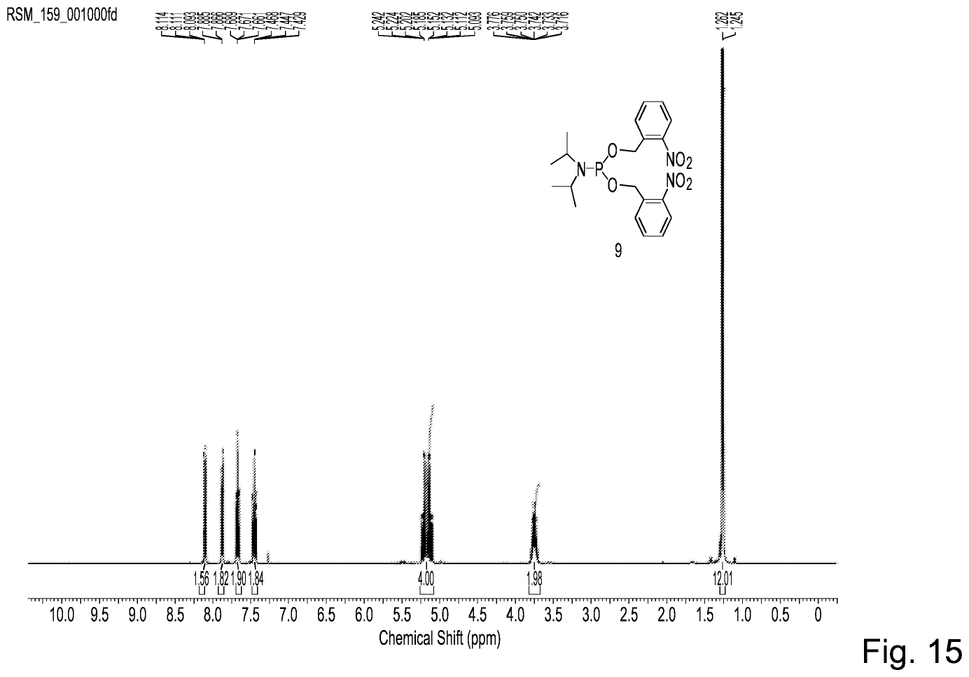

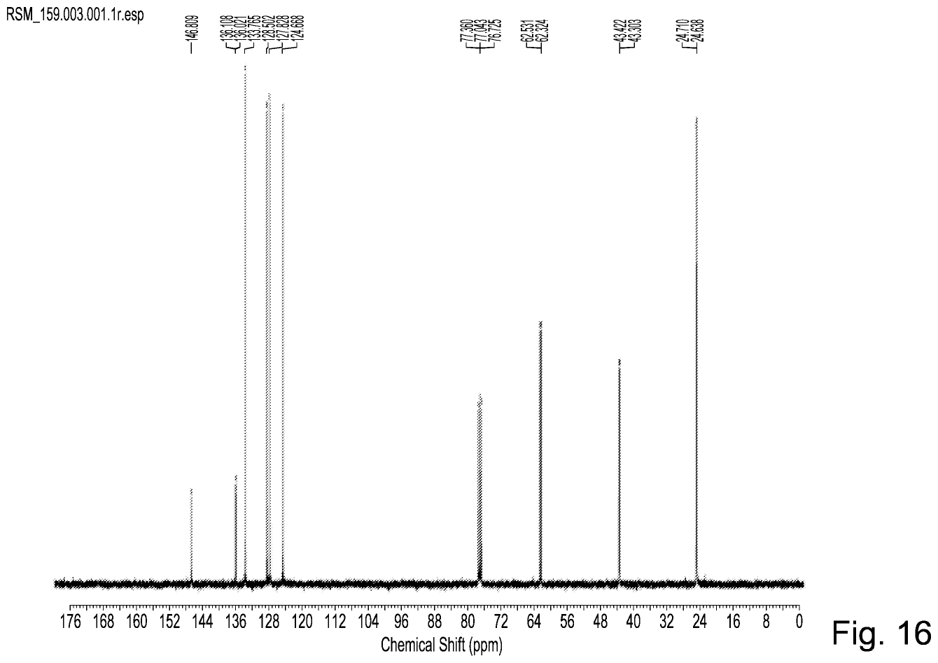

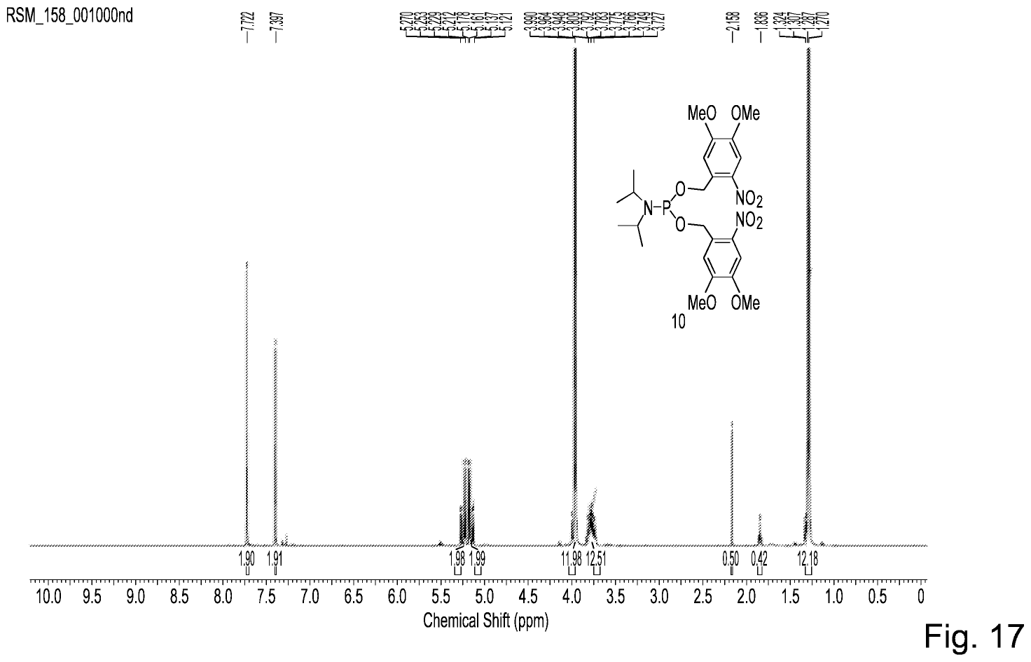

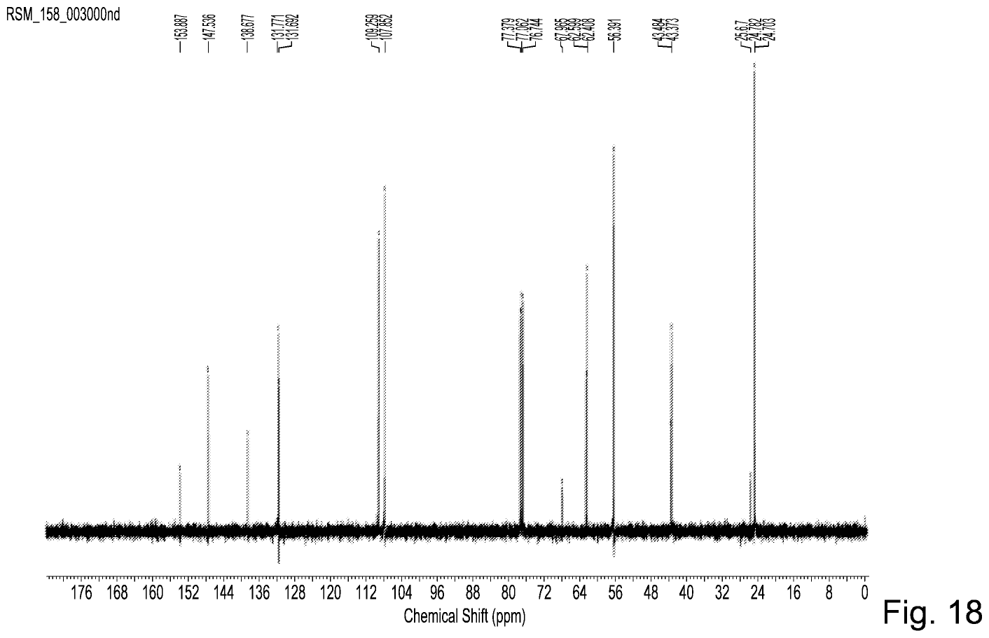

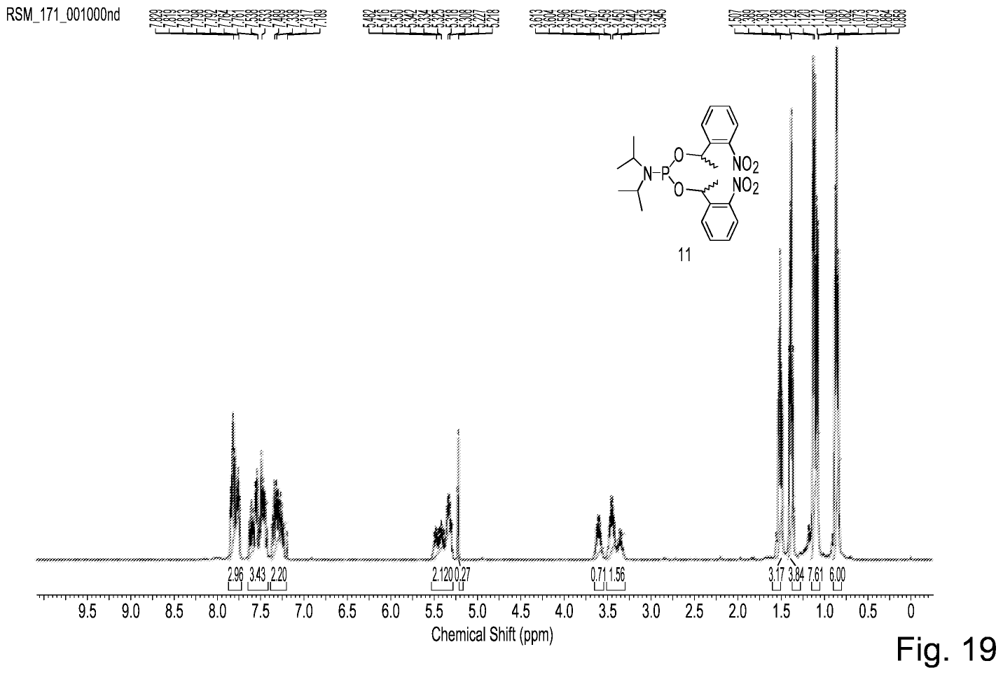

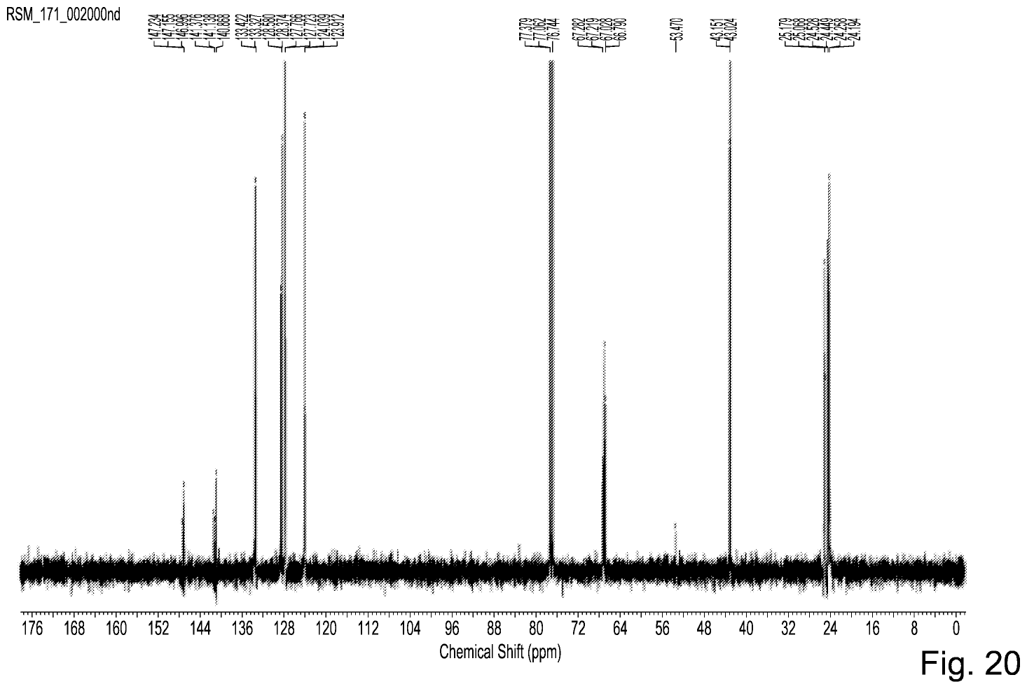

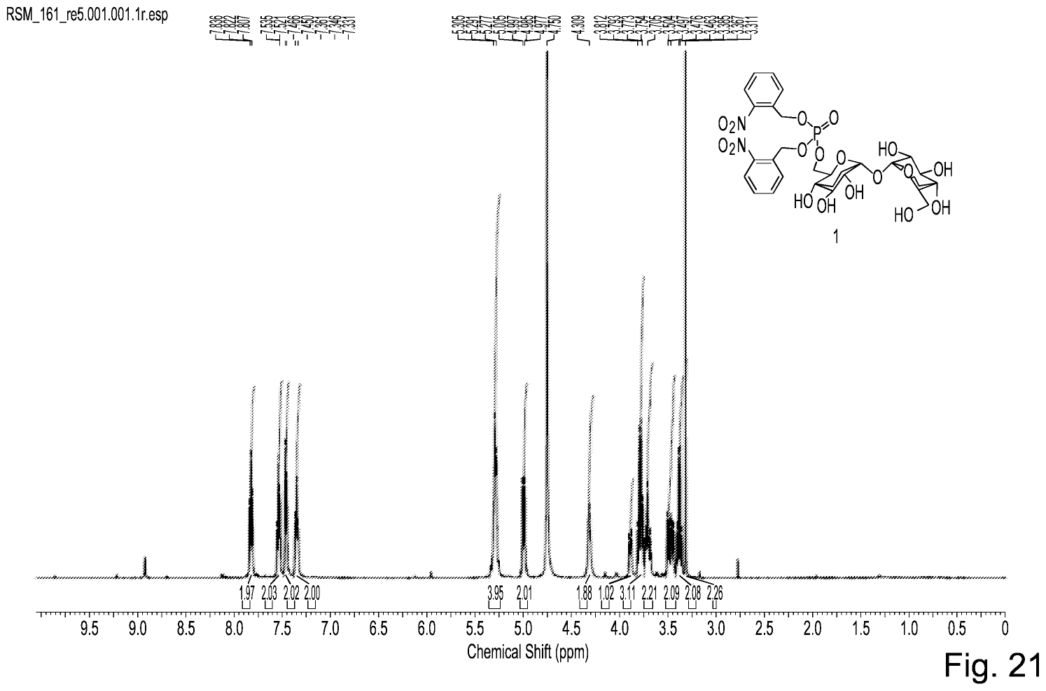

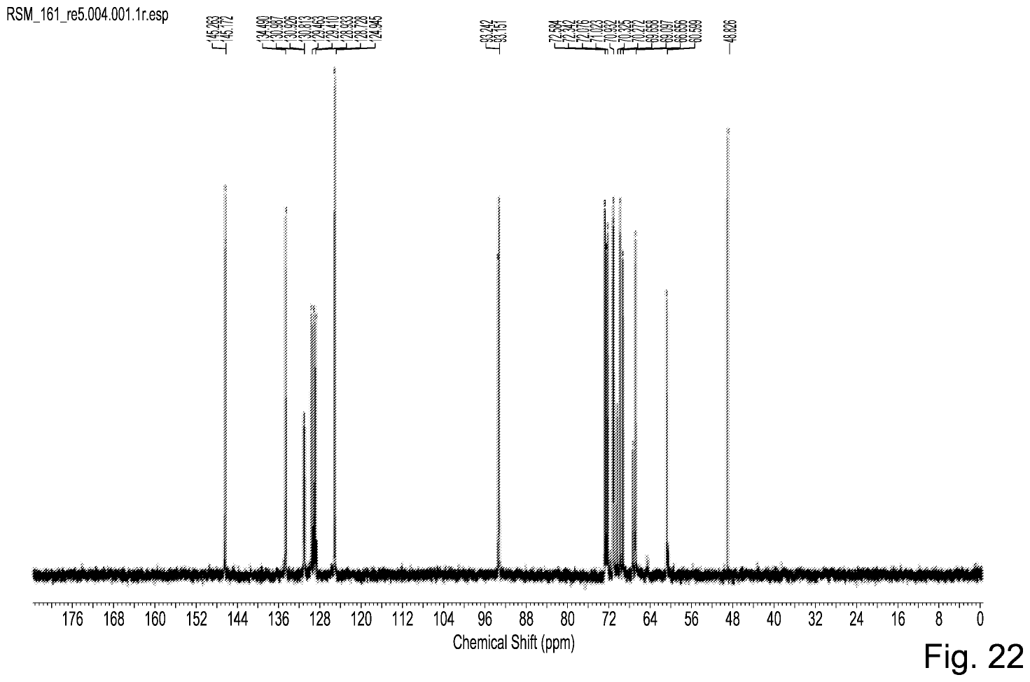

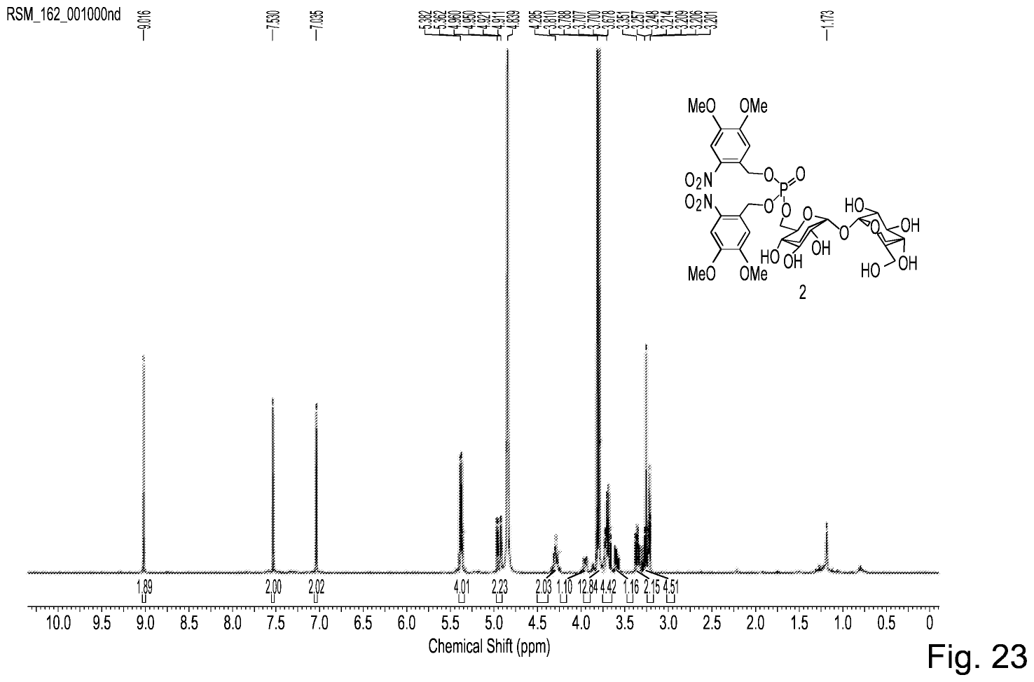

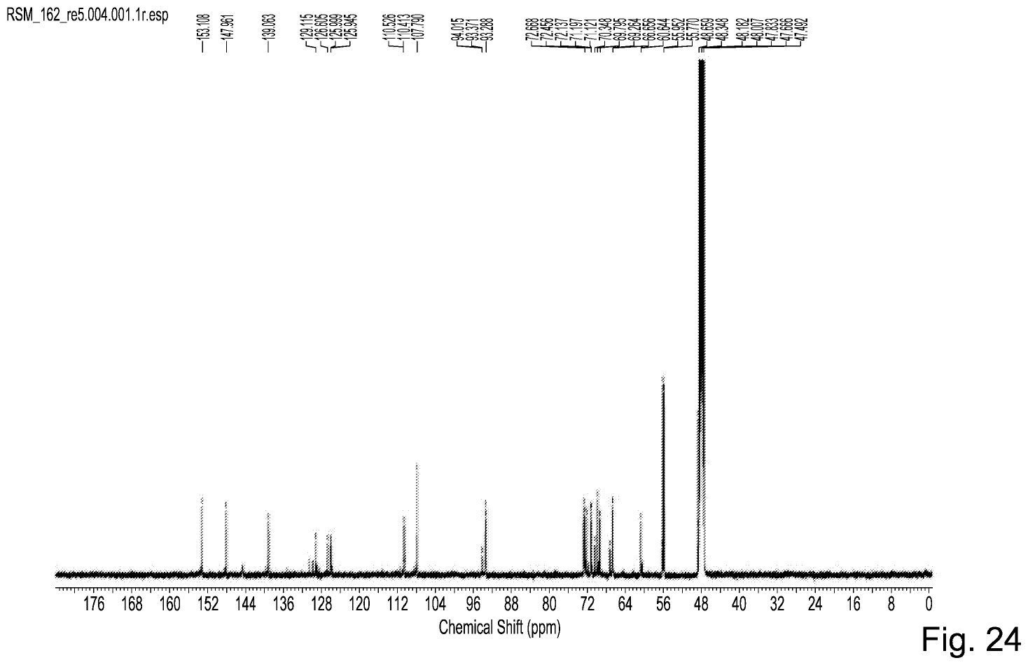

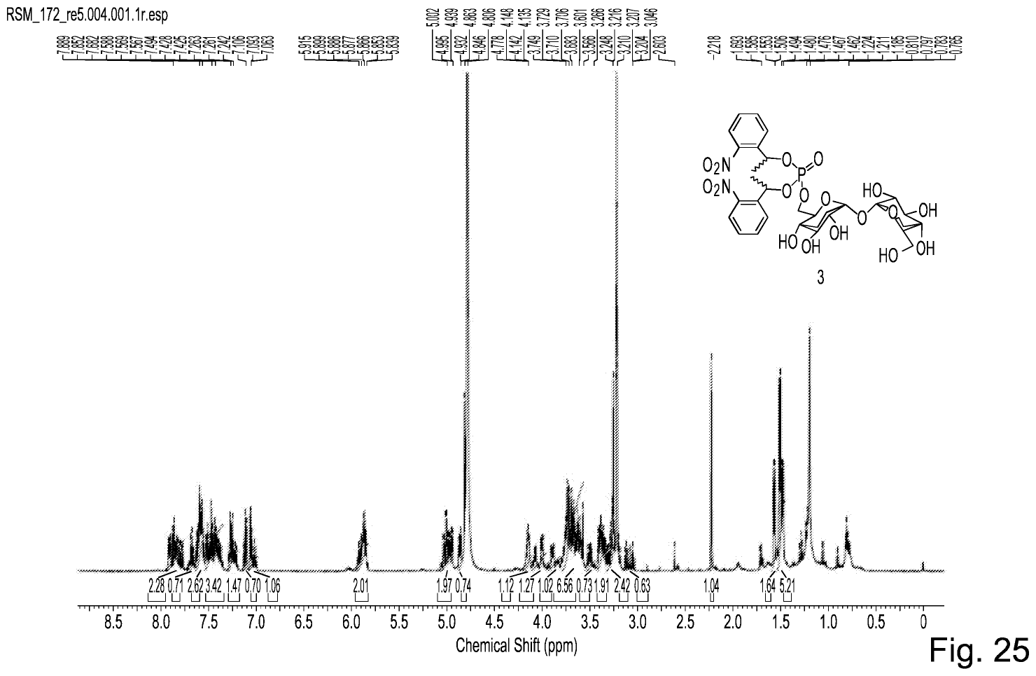

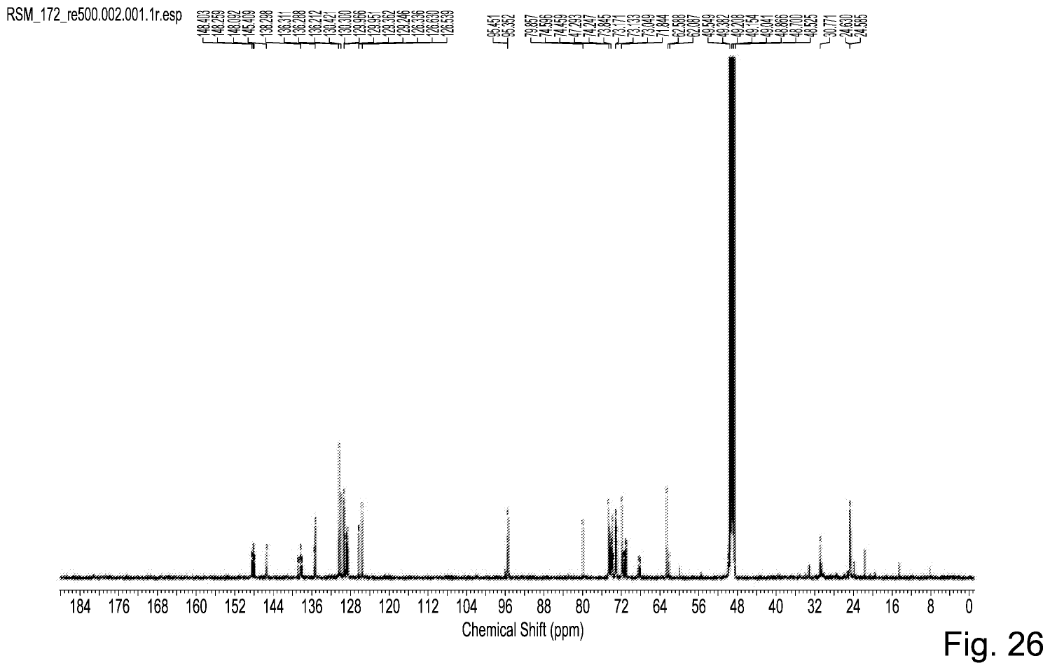

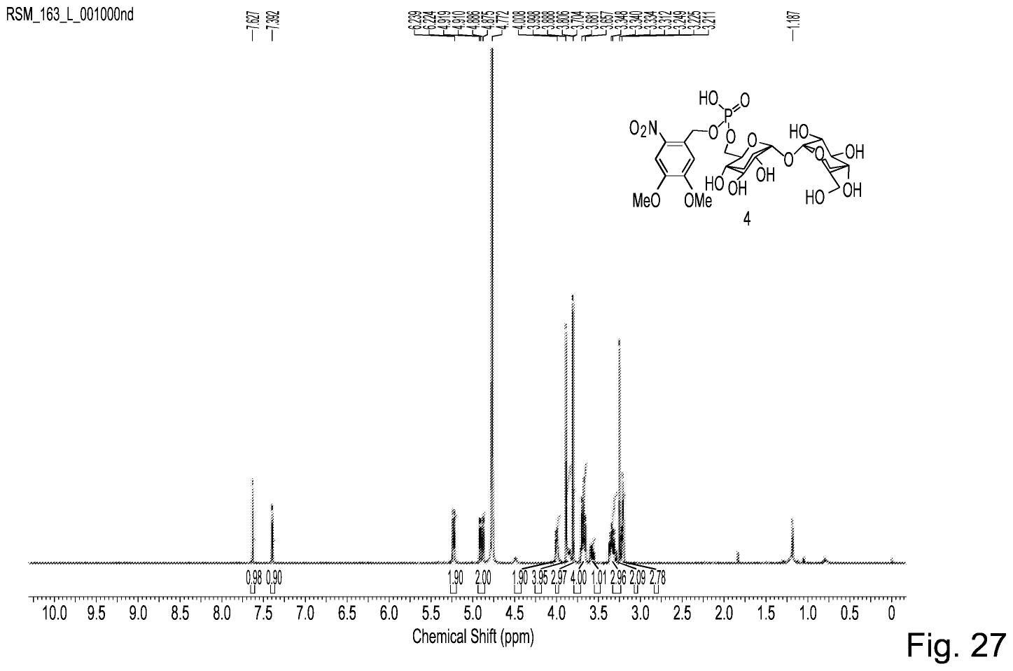

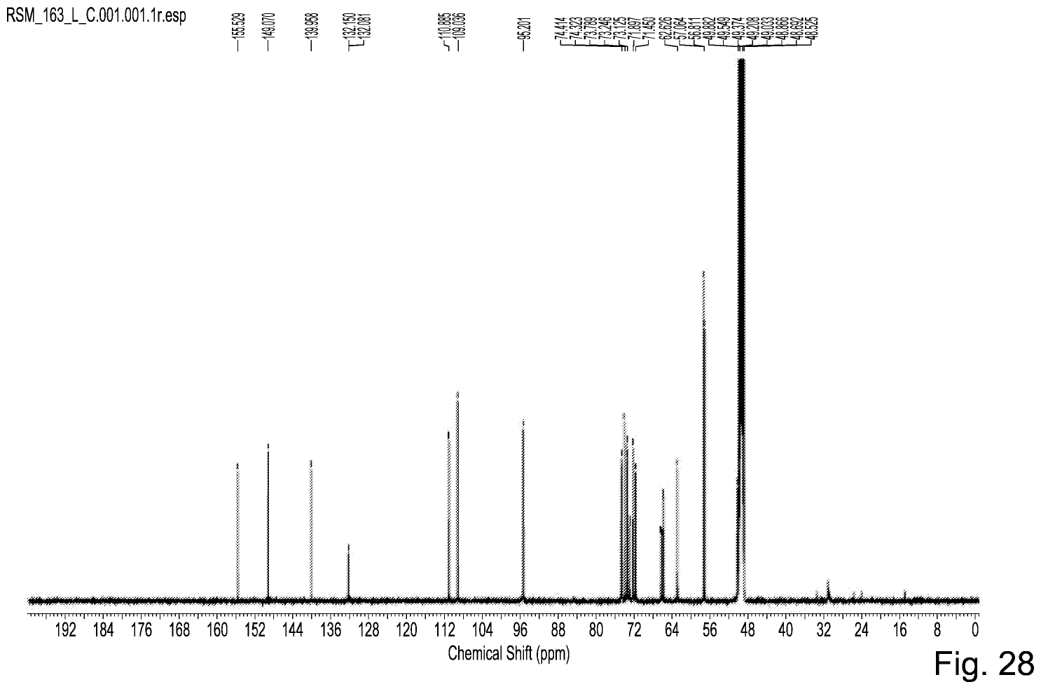

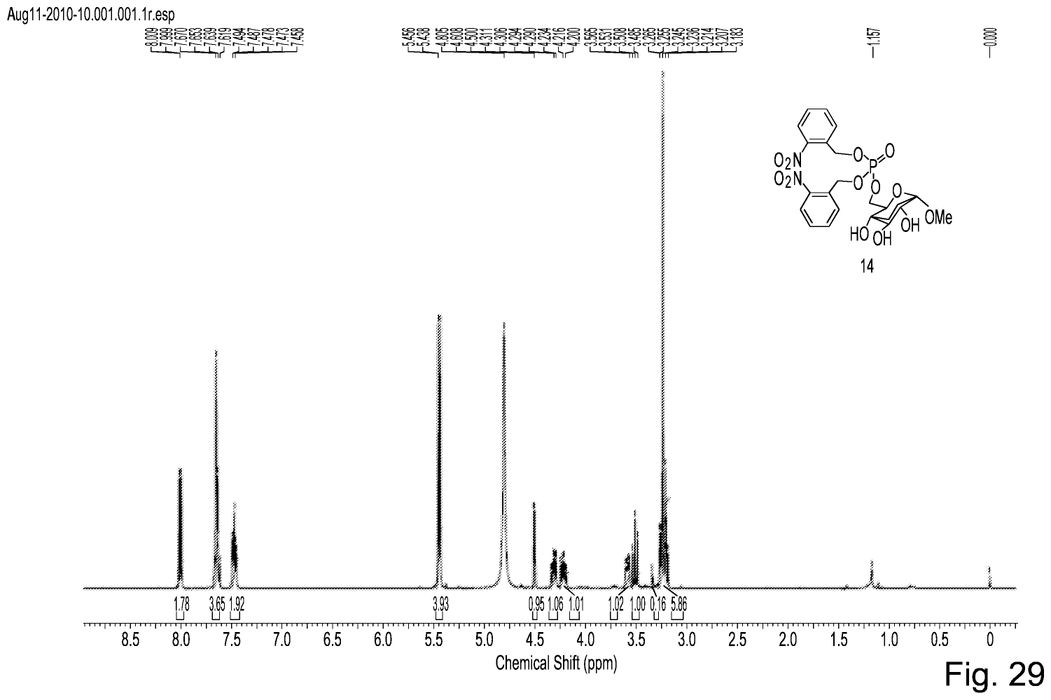

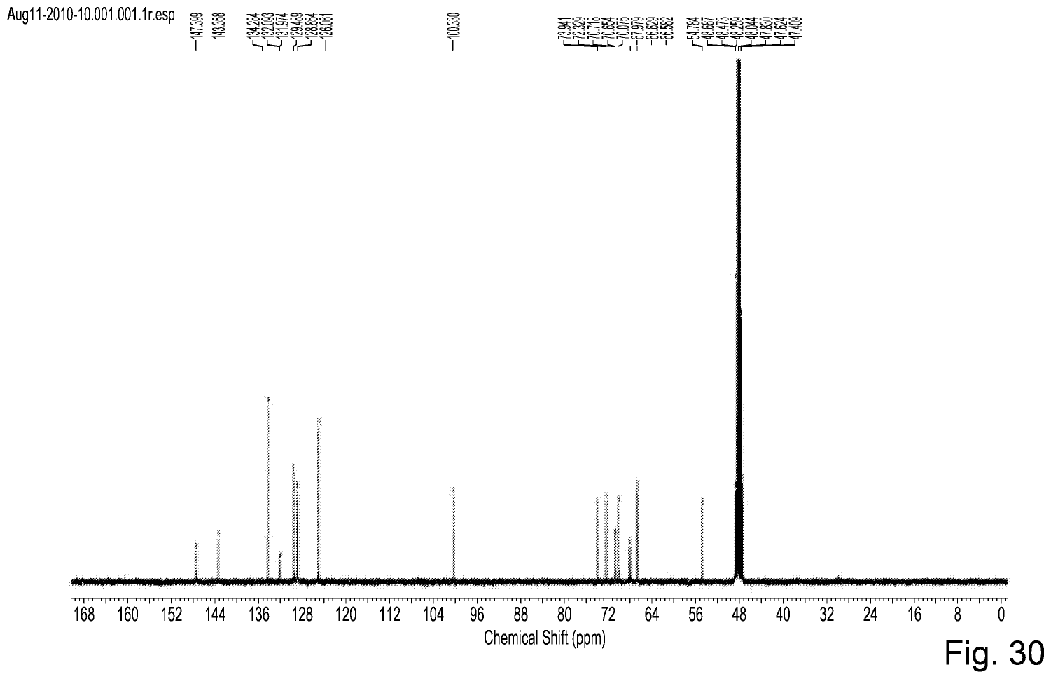

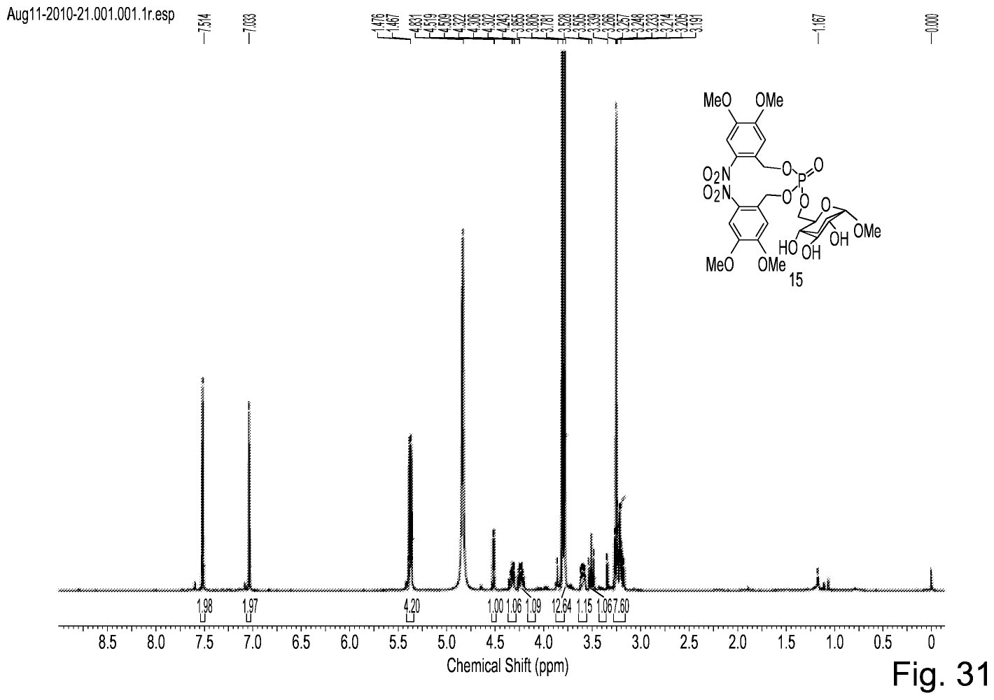

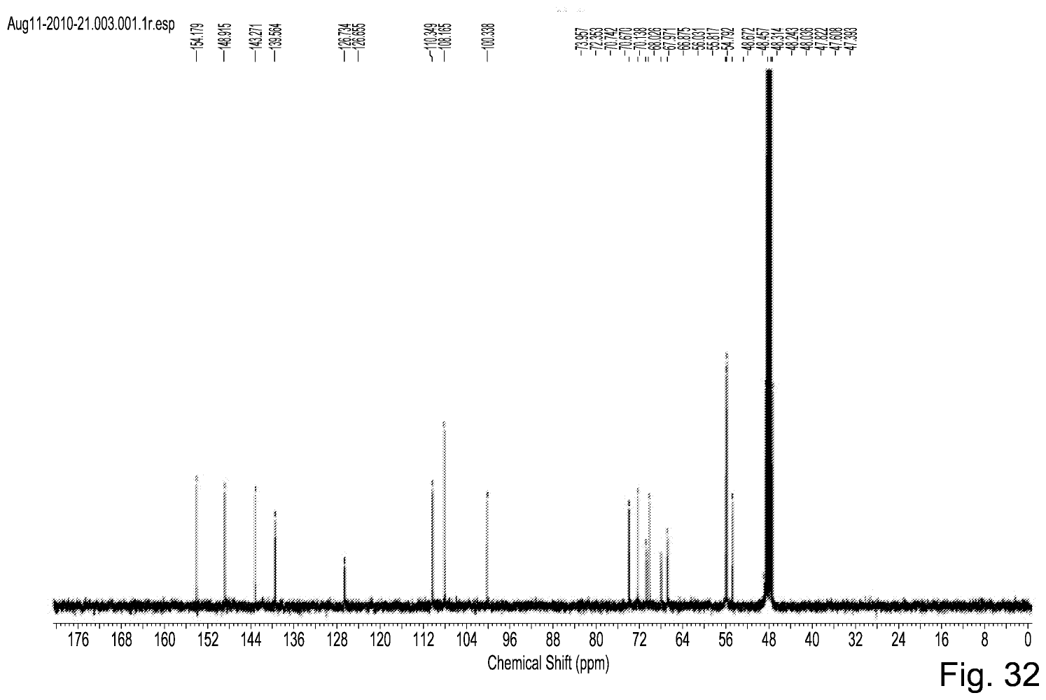

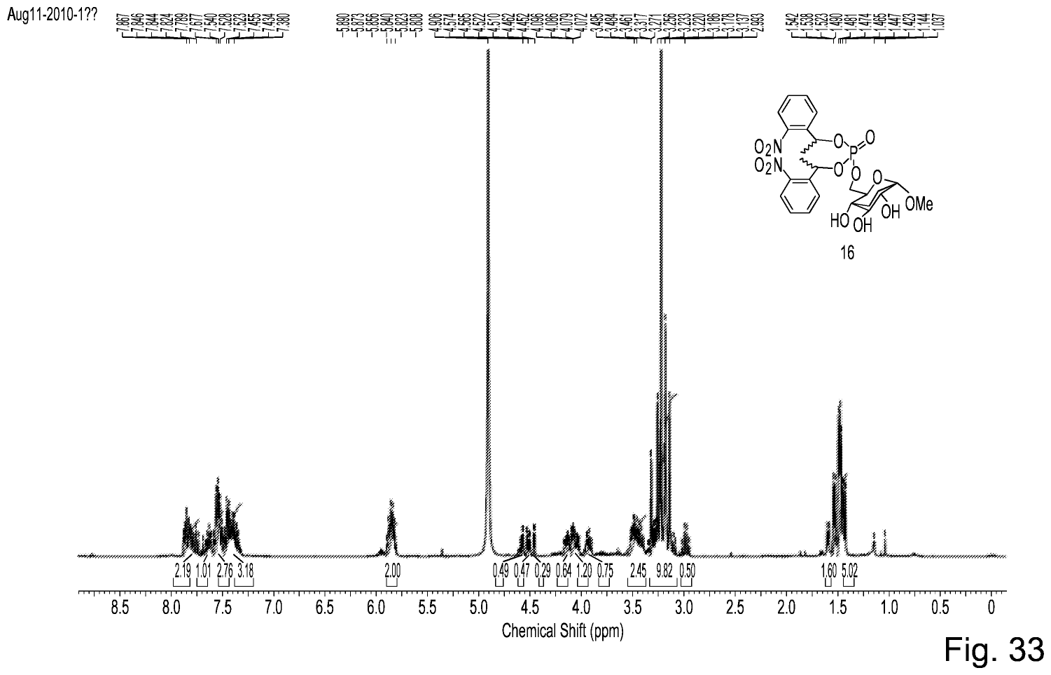

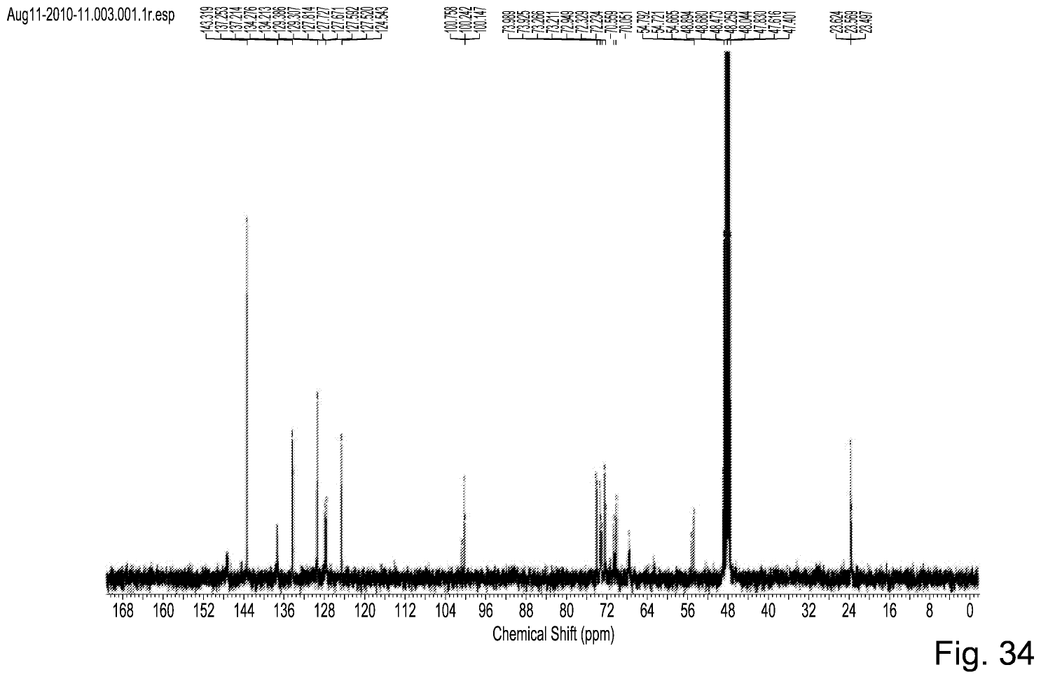

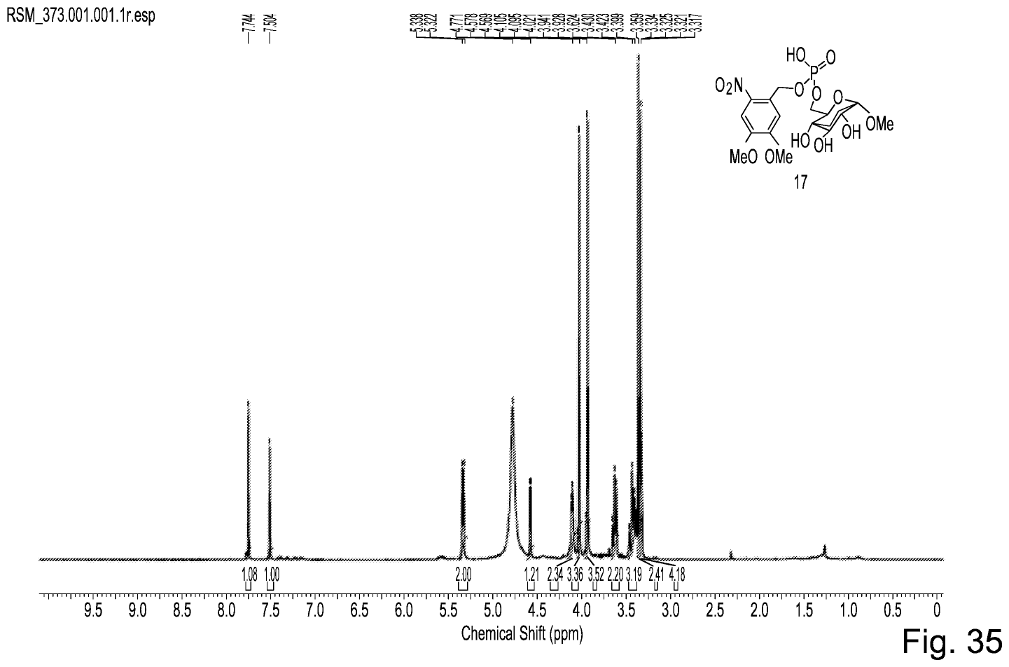

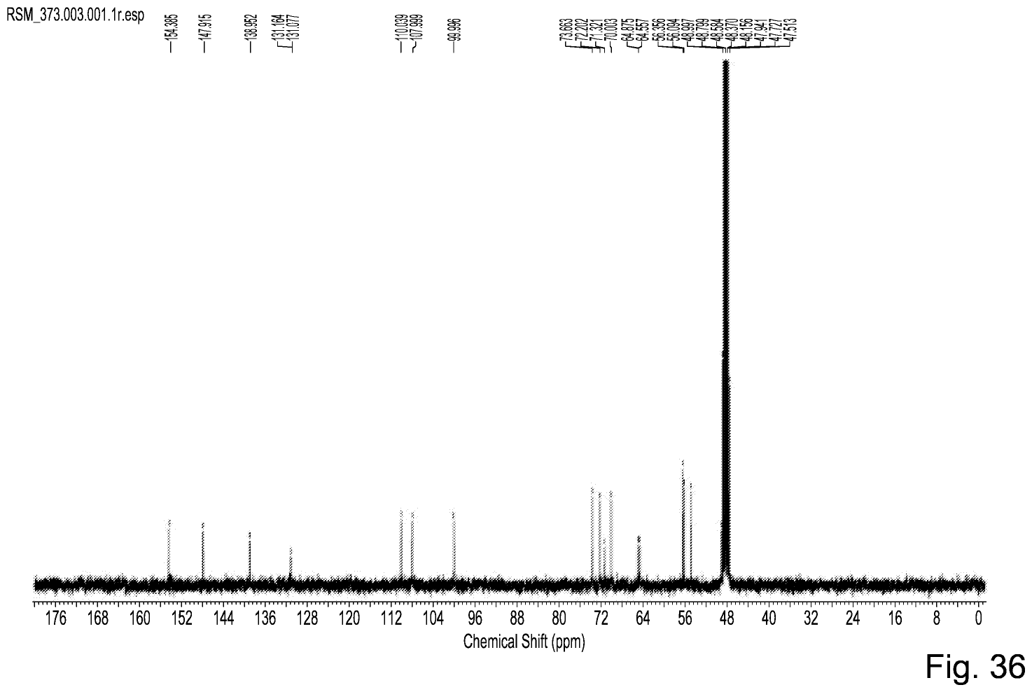

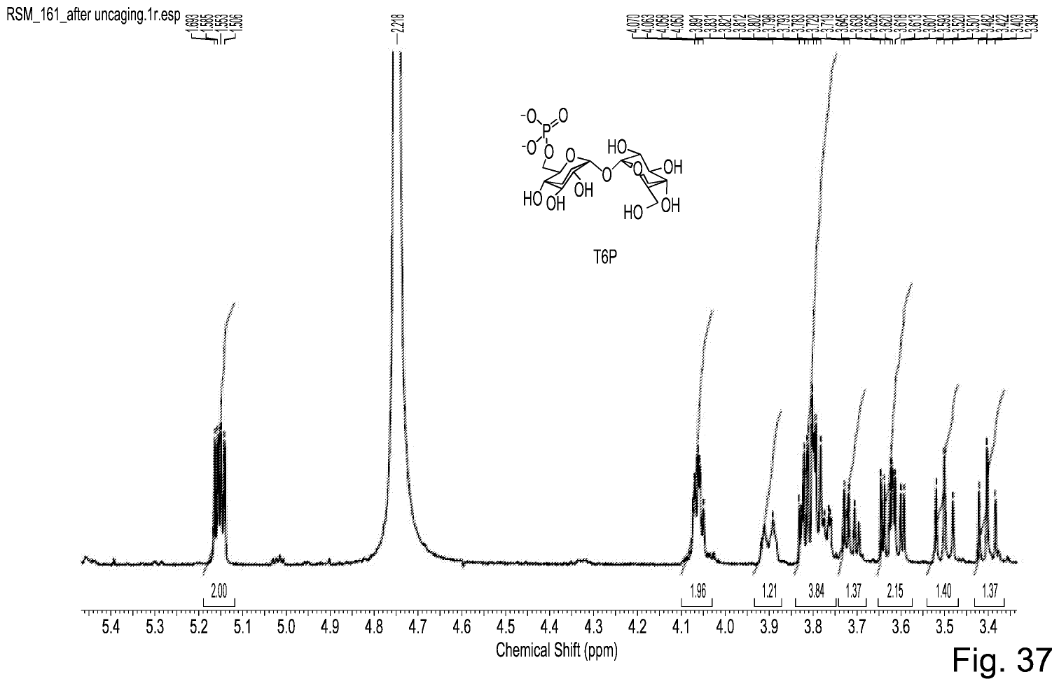

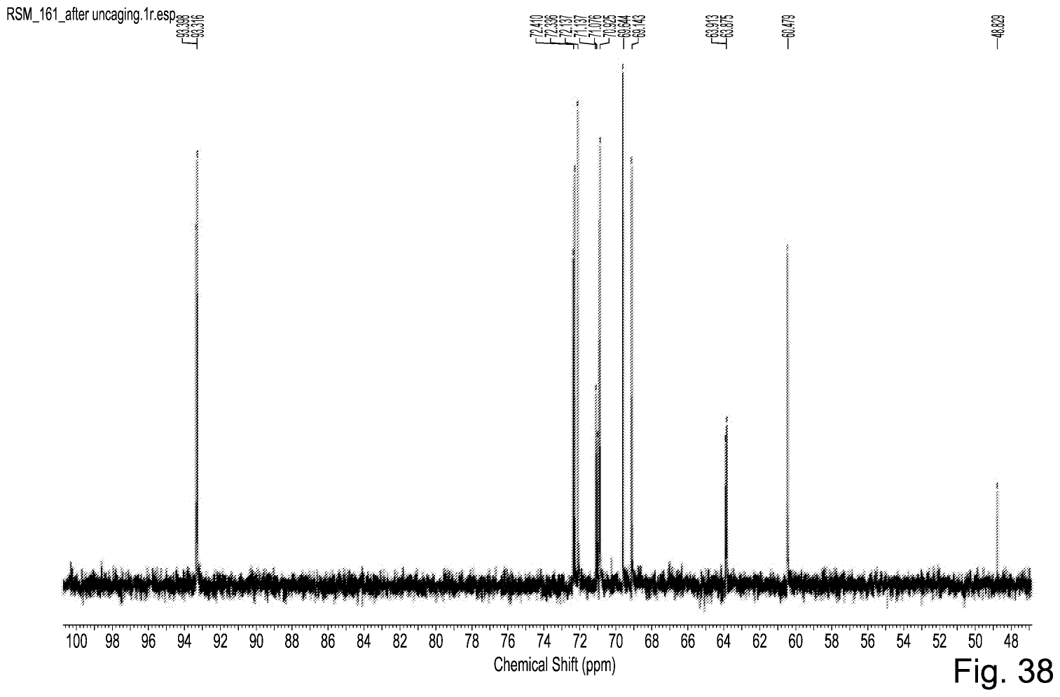

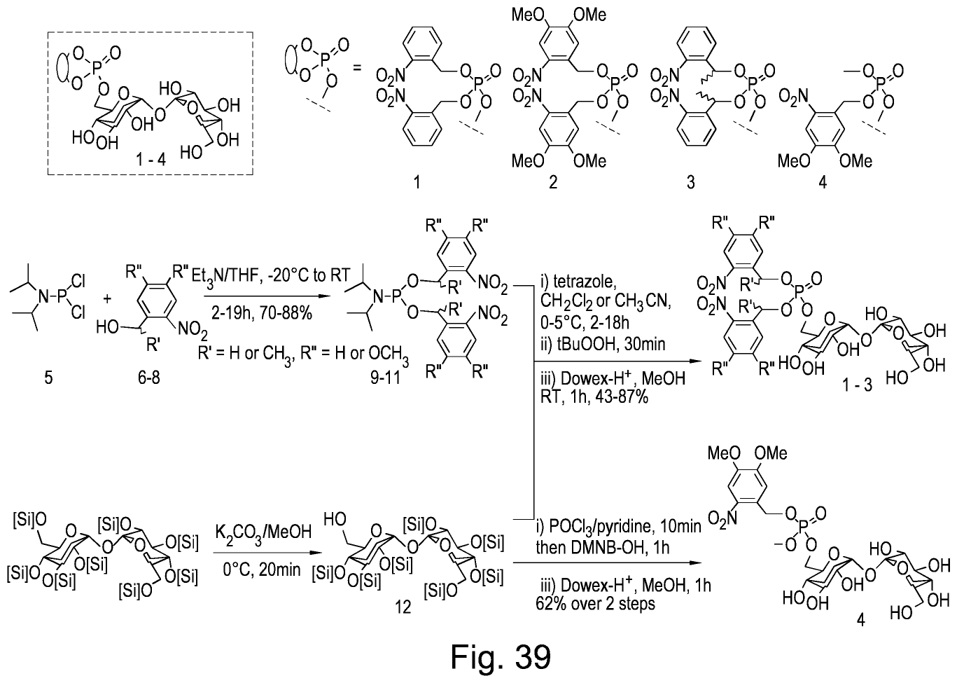

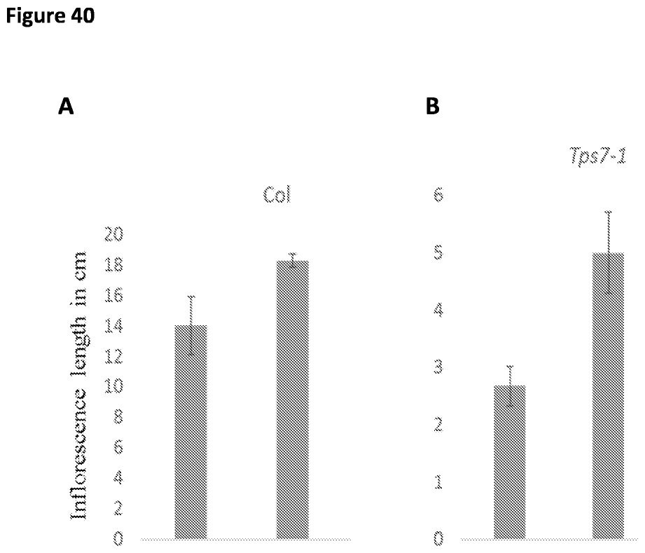

The ¹H and ¹³C NMR Spectra of all compounds are shown in FIGS. 15-38.

The signalling-precursor strategy was based on release by light (FIG. 2). Light-activated control is a potent strategy in biology because it can allow temporal and even spatial resolution that surpasses that of standard genetic methods (Mayer and Heckel. 2006, Angew Chem Int Ed Engi 45: 4900-4921). In principle, this resolution can be increased yet further when combined with small molecule chemical control given these too can be applied with localization and at predetermined time points (Adams and Tsien, 1993, Annu Rev Physiol 55: 755-784; Givens and Kueper, 1993, Chem. Rev. 93, 55-66; Ellis-Davies, 2007, Nat Methods 4: 619-628). The potency of such a method is increased further still when it leads to the release of a signalling molecule whose effect is amplified several fold. Notably, however, no such light-controlled approaches have, until now, been applied to sugar biology.

Additionally, hydrophilic sugar molecules or charged molecules do not readily cross into plants unless actively transported. It was hypothesized that unnatural precursors could be designed that contain groups that would both mask charge/increase hydrophobicity and also be released by light. Four water-soluble precursors (1-4) of T6P were selected (FIG. 3). Each contained different light-sensitive moieties that functionally encapsulated T6P in an inactive and neutral form to facilitate entry into cells and that would then be liberated into active molecule upon irradiation with light: ortho-nitrobenzyl (oNB) in 1; 4,5-dimethoxynitrobenzyl (DMNB) in 2 and 4 and 2-(ortho-nitrophenyl)ethyl (oNPE) in 3. These differing groups were intended to permit the generation of create precursors with different behaviours in light and to fine-tune both uptake and release through change of both physical and chemical properties.

Construction of the precursors (FIG. 3) used different phosphorus chemistries: phosphoramidite chemistry (Scheigetz and Roy. 2000, Synth. Commun. 30: 1437-1445; Arslan, et al., 1997, J. Am. Chem. Soc. 119: 10877-10887) to create P(III) intermediates that were then oxidized to corresponding P(V) phosphotriester intermediates or direct P(V) phosphorylation chemistry (FIG. 3). Regioselective access to the OH-6 group in trehalose was achieved through the use of trimethytsilyl (TMS) as a protecting group to form corresponding ethers. The TMS ether is chemically orthogonal to the phosphotriester group found in each of the light-sensitive moieties and its removal under mildly acidic conditions was successfully achieved. This was important since phosphate esters are highly prone to migration under basic conditions (Billington, 1989, Chem. Soc. Rev. 18: 83-122). Thus. Intermediate 12 was prepared in gram quantities by regioselective removal of an 0-6 TMS ether group on persilylated trehalose (Ronnow et al., (1994) Carbohydr. Res. 260: 323-328). Overall phosphorylation of the revealed OH-6 hydroxyl in 12 involved reaction with phosphoramidites 9-11 (Scheigetz and Roy, 2000, Synth. Commun. 30: 1437-1445; Arslan, et al., 1997. J. Am. Chem. Soc. 119: 10877-10887) followed by in situ oxidation using tBuOOH. Using alternative direct P(V) chemistry a variant containing only a single DMNB was also created to explore the effect of different copy numbers of light-sensitive moieties: 12 was treated with 1 equiv. of POCl3 in pyridine (Meldal et al., (1992) Carbohydr. Res. 235: 115-127) followed by the addition of DMNB alcohol. Finally, all of the resulting intermediates were stirred in methanol in the presence of Dowex-H+ to induce mild deprotection which furnished the corresponding signalling precursors 1-4 (see SI). This synthetic route proved efficient and effective, allowing preparation of grams of signalling precursors at scales for application in plant trials (vide infra).

### Example 2. Ectopic Application of TSP Chemicals Controls Flowering Time in Arabidopsis Plants

To demonstrate efficacy of T6P chemicals to regulate flowering, Arabidopsis thaliana wild type and a delayed flowering mutant (attps7) have been used. In both cases it is possible to advance the development of the flowering inflorescence by several centimetres and advance flowering time by up to a week.

### Plant Growth Conditions

Seeds of Arabidopsis thaliana, ecotype Columbia (Col-0) and attps7 knockout mutants were surface-sterilized with 70% of ethanol for 2 min and 75% household bleach for 7 min, and grown on nutrient agar media (0.5×Murashige and Skoog plus Gamborg's vitamins (Sigma). 0.5% Sucrose and 0.7% Agar) in Petri plates. Seeds on the Petri plates were placed in a growth chamber (22° C., 150 μmol m⁻² s⁻¹, 16-h day). Seven days after plating, seedlings were transferred to pots of soil containing Rothamsted standard compost mix and full nutrition (one seedling per pot). Forty plants per A. thaliana type (n=40 Col-0, n=40 TPS7_3, n=40 TPS7_4.15) were grown at 22CC, 250 μmol m⁻² s⁻¹ irradiance, 16-h day. Eight days after sowing (DAS) plants were sprayed with 0.5 ml 1 mM oNPE-T6P (ortho-nitrphenyl)ethyl trehalose 6-phosphate dissolved in distilled water with the addition of 0.1% of Tween20 during the middle of the mid-photoperiod. Twenty-four hours after spraying (9 DAS), plants sprayed with 1 mM oNPE-T6P were exposed to 600 μmol m⁻² s⁻¹ irradiance for 1 h to release T6P from oNPE-T6P. Spraying was repeated at 12 and 16 DAS.

First, the appearance of the flower bud was quicker in plants sprayed with oNPE-T6P than with water.

TABLE 1
The number of flower buds that had appeared at day 5 after
spraying in Col-0 and tps7 mutants. In all cases more flower
buds had appeared in oNPE-treated plants compared to control
shown as crosses in highlighted boxes (100% in Col-0, 90%
and 90% in tps7 mutants compared to 70%, 70% and 30% in
Col-0, and tps7 mutants treated with water only.

| | Water (control) | | | 1 mM oNPE-T6P | | |
|---|---|---|---|---|---|---|
| | Day 5 | | | Day 5 | | |
| N | Col-0 | TPS7_3 | TPS7_4.15 | Col-0 | TPS7_3 | TPS7_4.15 |
| 1 | X | X | | X | X | X |
| 2 | X | X | | X | X | X |
| 3 | | X | | X | X | X |
| 4 | X | | | X | X | X |
| 5 | X | | X | X | X | X |
| 6 | X | X | | X | | X |
| 7 | X | | X | X | X | X |
| 8 | | X | | X | X | X |
| 9 | X | X | X | X | X | X |
| 10 | | X | | X | X | |

Height of the flowering inflorescence was then measured at 26 DAS. Treatment with 1 mM oNPE in Col-0 and tps7 resulted in taller inflorescences (right hand bars in each case compared to left hand bars which represent water controls) (FIG. 40). This reflects the advancement of flowering by oNPE.

T6P chemicals therefore represent a novel way to control flowering time in plants.

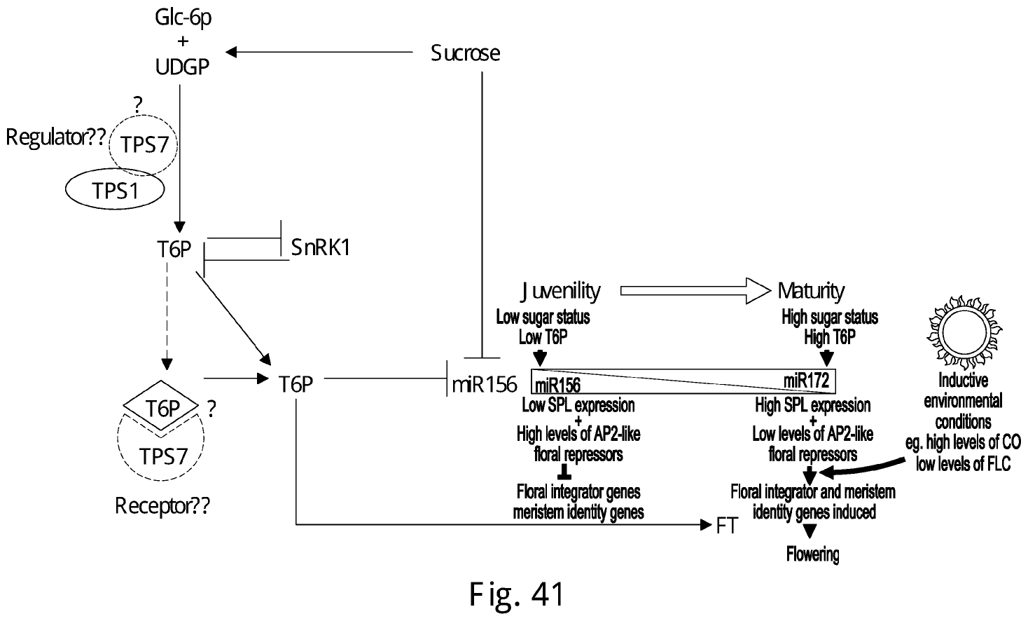

The molecular basis of the signalling pathway involved in transducing the T6P sugar signal for flowering is not well understood. Without wishing to be bound by any particular theory, the generic nature of T6P signalling in plants and crops indicates that T6P is a universal mechanism for the control of flowering time. A possible role of T6P and tps7 in control of flowering in plants and crops is illustrated in FIG. 41.

T6P chemicals therefore provide a direct method to control flowering time without the need for complex genetics. Flowering time, flowering time coordination and repeat flowering can be controlled with the T6P chemicals.

1. A method of inducing flowering in a plant, wherein the method comprises treating the plant with a compound of formula (I), a phosphonate analogue thereof, or agriculturally acceptable salts thereof: 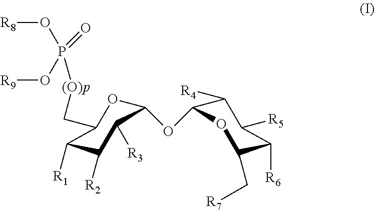
wherein:
p is 0 or 1;
R₁ to R₇ independently represent F, N₃, NR′R″, C₁₋₄ alkyl, —(C₁₋₄ alkyl)OH or OH, wherein R′ and R″ independently represent hydrogen or C₁₋₄ alkyl;
and R₈ and R₉ are the same or different and represent H or a photo-labile protecting group, wherein at least one of R₈ and R₉ represents a photo-labile protecting group.

2. The method of claim 1, wherein the photo-labile protecting group is of formula (II): 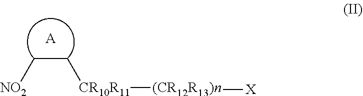
wherein;
(a) ring A represents an aryl or heterocyclic group; or
(b) ring A represents a C₆₋₁₀ aryl group or a 5- to 14-membered heterocyclic group containing one or more atoms selected from N, O and S, wherein the aryl or heterocyclic group is unsubstituted or substituted with one or more substituents selected from C₁₋₄ alkyl, —OR′, halogen, CN, —NR′R″, —COOR′, —(C₁₋₄alkyl)COOR′ and —O(C₁₋₄alkyl)COOR′, wherein R′ and R″ are independently selected from hydrogen and C₁₋₄ alkyl, or wherein two adjacent substituents on the aryl or heterocyclic group together form a 5- or 6-membered heterocyclic ring containing one or more heteroatoms selected from N, O or S; or
(c) ring A represents a phenyl, naphthalenyl or dibenzofuranyl ring;
either (i) R₁₀ and R₁₁ are the same or different and are selected from hydrogen, C₁₋₄ alkyl which is unsubstituted or substituted with one or more halogen atoms, —OR′, halogen, —NR′R″ or —CO₂R′, wherein R′ and R″ are independently selected from hydrogen and C₁₋₄ alkyl, or (ii) two R₁₀ groups on adjacent photo-labile protecting groups together form a bond and R₁₁ represents hydrogen, C₁₋₄ alkyl which is unsubstituted or substituted with one or more halogen atoms, —OR′, halogen, —NR′R″ or —CO₂R′, wherein R′ and R″ are independently selected from hydrogen and C₁₋₄ alkyl; n is 0 or 1; and
R₁₂ and R₁₃ are the same or different and are selected from hydrogen, C₁₋₄ alkyl which is unsubstituted or substituted with one or more halogen atoms, —OR′, halogen, —NR′R″ or —CO₂R′, wherein R′ and R″ are independently selected from hydrogen and C₁₋₄ alkyl; wherein X represents the link to the remainder of the compound of formula (I): preferably wherein the photo-labile group is selected from: 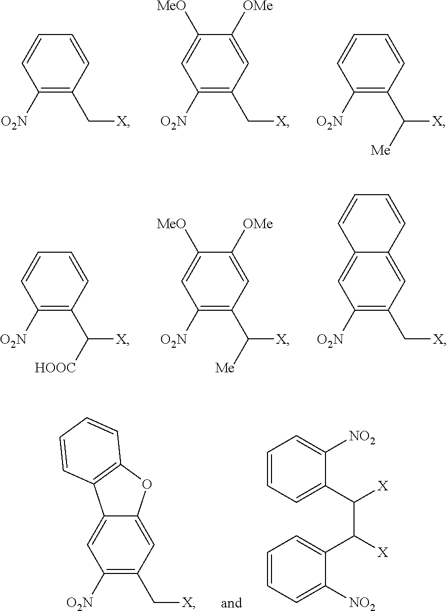
wherein X represents the link to the remainder of the compound of formula (I).

3. (canceled)

4. The method of claim 1, wherein the photo-labile protecting group is of formula (III): 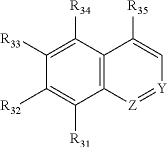
wherein
either Z represents N, Y represents CR₃₆ and Z and Y are linked by a double bond; or
Z represents O, Y represents C═O and Z and Y are linked by a single bond;
R₃₆ represents —CR₃₇R₃₈X;
when Y represents CR₃₆, R₃₅ represents hydrogen, and when Y represents C═O, R₃₅ represents —CR₃₇R₃₈X;
either (i) R₃₇ and R₃₈ are the same or different and are selected from hydrogen, C₁₋₄ alkyl which is unsubstituted or substituted with one or more halogen atoms, —OR′, halogen, —NR′R″ or —CO₂R′ wherein R′ and R″ are independently selected from hydrogen and C₁₋₄ alkyl, or (ii) two R₃₇ groups on adjacent photolabile protecting groups together form a bond and R₃₈ represents hydrogen, C₁₋₄ alkyl which is unsubstituted or substituted with one or more halogen atoms, —OR′, halogen, —NR′R″ or —CO₂R′ wherein R′ and R″ are independently selected from hydrogen and C₁₋₄ alkyl;
R₃₂ represents —OR′, —NR′R″, —O(C₁₋₄alkyl)-COOR′, —O(C₁₋₄alkyl)-OR′ or —O(C₁₋₄alkyl)-NR′R″, wherein R′ and R″ independently represent hydrogen or C₁₋₄ alkyl; and R₃₁, R₃₃ and R₃₄ are independently selected from hydrogen, halogen, —OR′, —NR′R″, —O(C₁₋₄alkyl)-COOR′, —O(C₁₋₄alkyl)-OR′ or —O(C₁₋₄alkyl)-NR′R″, wherein R′ and R″ independently represent hydrogen or C₁₋₄alkyl; wherein X represents the link to the remainder of the compound of formula (I) preferably wherein the photo-labile protecting group is selected from:

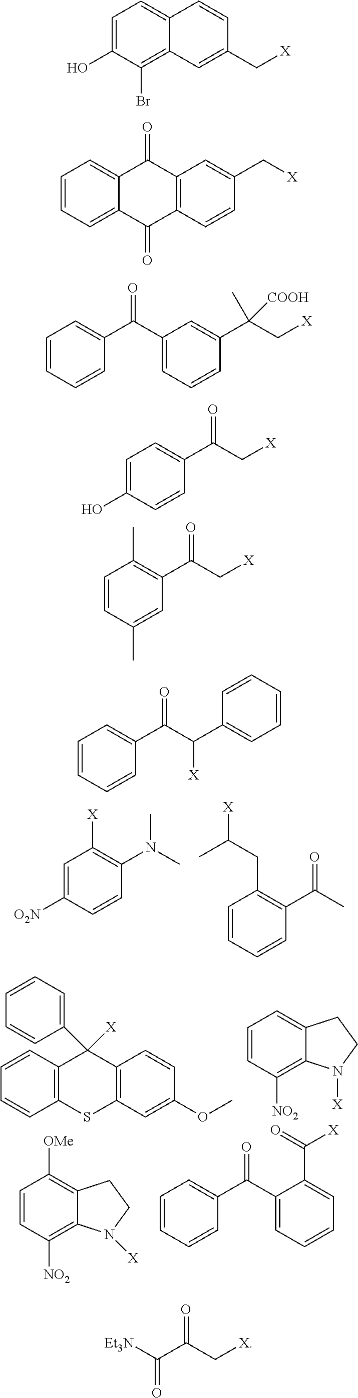

5. (canceled)

6. (canceled)

7. (canceled)

8. The method of claim 1, wherein: (a) the photo-labile protecting group is of formula (IIa): 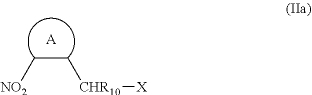
wherein; ring A represents an unsubstituted or substituted group selected from phenyl, naphthyl or dibenzofuranyl, wherein a substituted phenyl, naphthyl or dibenzofuranyl group is a phenyl, naphthyl or dibenzofuranyl group having one or two methoxy substituents, or a phenyl, naphthyl or dibenzofuranyl group wherein two adjacent ring positions are substituted with a —CH₂—O—CH₂— moiety; and R₁₀ represents hydrogen, methyl, —CF3 or —COOH; wherein X represents the link to the remainder of the compound of formula (I) or (b) the photolabile protecting group is of formula (IIIa): 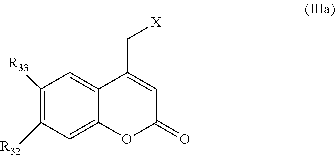
wherein:
R₃₂ represents —OR′, —NR′R″ or —O(C₁₋₄alkyl)-COOR′, wherein R′ and R″ independently represent hydrogen or C₁₋₂ alkyl; and
R₃₃ represents hydrogen, Br, —OR′, —NR′R″ or —O(C₁₋₄alkyl)-COOR′, wherein R′ and R″ independently represent hydrogen or C₁₋₂ alkyl;
wherein X represents the link to the remainder of the compound of formula (I); preferably wherein:
a) R₃₃ represents H and R₃₂ represents OMe, NMe₂, NEt₂ or —OCH₂COOH; or
b) R₃₃ represents Br and R₃₂ represents OH; or
c) R₃₃ and R₃₂ both represent —OCH₂COOH.

9. (canceled)

10. (canceled)

11. (canceled)

12. (canceled)

13. The method of claim 1, wherein the plant is a dicotyledonous plant: preferably wherein the plant is a Brassica plant.

14. (canceled)

15. (canceled)

16. A method of accelerating the floral development of a plant, wherein the method comprises treating the plant with a compound of formula (I), a phosphonate analogue thereof, or agriculturally acceptable salts thereof: 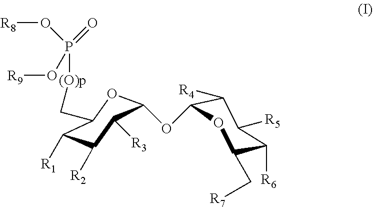
wherein:
p is 0 or 1;
R₁ to R₇ independently represent F, N₃, NR′R′, C₁₋₄ alkyl, —(C₁₋₄ alkyl)OH or OH, wherein R′ and R″ independently represent hydrogen or C₁₋₄ alkyl;
and R₈ and R₉ are the same or different and represent H or a photo-labile protecting group, wherein at least one of R₈ and R₉ represents a photo-labile protecting group.

17. The method of claim 1, wherein the method comprises treating the plant in a vegetative growth phase.

18. The method of claim 1, wherein the compound is applied together with at least one fertilizer, fungicide, herbicide, insecticide or plant growth regulator.

19. (canceled)

20. (canceled)

21. The method of claim 1, wherein the plant has a greater number of floral buds compared with untreated plants.

22. A method of co-ordinating the floral development of plants, comprising treating the growing plants with a compound as of formula (I), a phosphonate analogue thereof, or agriculturally acceptable salts thereof: 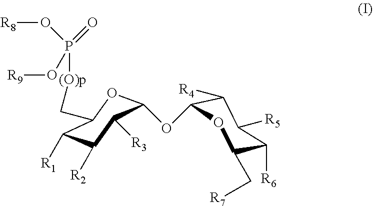
wherein:
p is 0 or 1;
R₁ to R₇ independently represent F, N₃, NR′R″, C₁₋₄alkyl, —(C₁₋₄alkyl)OH or OH, wherein R′ and R″ independently represent hydrogen or C₁₋₄alkyl;
and R₈ and R₉ are the same or different and represent H or a photo-labile protecting group, wherein at least one of R₈ and R₉ represents a photo-labile protecting group.

23. The method of claim 16, wherein the photo-labile protecting group is of formula (II): 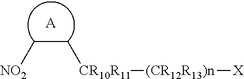
wherein;
(a) ring A represents an aryl or heterocyclic group; or
(b) ring A represents a C₆₋₁₀ aryl group or a 5- to 14-membered heterocyclic group containing one or more atoms selected from N, O and S, wherein the aryl or heterocyclic group is unsubstituted or substituted with one or more substituents selected from C₁₋₄ alkyl, —OR′, halogen, CN, —NR′R″, —COOR′, —(C₁₋₄alkyl)COOR′ and —O(C₁₋₄alkyl)COOR′, wherein R′ and R″ are independently selected from hydrogen and C₁₋₄ alkyl, or wherein two adjacent substituents on the aryl or heterocyclic group together form a 5- or 6-membered heterocyclic ring containing one or more heteroatoms selected from N, O or S; or
(c) ring A represents a phenyl, naphthalenyl or dibenzofuranyl ring;
either (i) R₁₀ and R₁₁ are the same or different and are selected from hydrogen, C₁₋₄ alkyl which is unsubstituted or substituted with one or more halogen atoms, —OR′, halogen, —NR′R″ or —CO₂R′, wherein R′ and R″ are independently selected from hydrogen and C₁₋₄ alkyl, or (ii) two R₁₀ groups on adjacent photo-labile protecting groups together form a bond and R₁₁ represents hydrogen, C₁₋₄alkyl which is unsubstituted or substituted with one or more halogen atoms, —OR′, halogen, —NR′R″ or —CO₂R′, wherein R′ and R″ are independently selected from hydrogen and C₁₋₄ alkyl; n is 0 or 1; and R₁₂ and R₁₃ are the same or different and are selected from hydrogen, C₁₋₄ alkyl which is unsubstituted or substituted with one or more halogen atoms, —OR′, halogen, —NR′R″ or —CO₂R′, wherein R′ and R″ are independently selected from hydrogen and C₁₋₄ alkyl; wherein X represents the link to the remainder of the compound of formula (I); preferably wherein the photo-labile group is selected from: 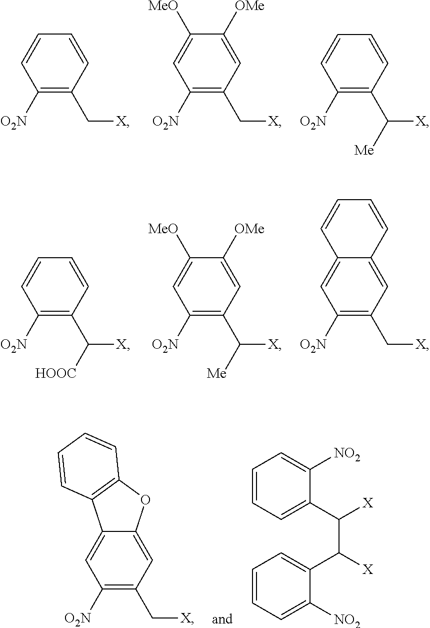
wherein X represents the link to the remainder of the compound of formula (I).

24. The method of claim 16, wherein the photo-labile protecting group is of formula (III): 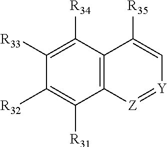
wherein:
either Z represents N, Y represents CR₃₆ and Z and Y are linked by a double bond; or
Z represents O, Y represents C═O and Z and Y are linked by a single bond;
R₃₆ represents —CR₃₇R₃₈X;
when Y represents CR₃₆, R₃₅ represents hydrogen, and when Y represents C═O, R₃₅ represents —CR₃₇R₃₈X;
either (i) R₃₇ and R₃₈ are the same or different and are selected from hydrogen, C₁₋₄ alkyl which is unsubstituted or substituted with one or more halogen atoms;
—OR′, halogen, —NR′R″ or —CO₂R′, wherein R′ and R″ are independently selected from hydrogen and C₁₋₄ alkyl, or (ii) two R₃₇ groups on adjacent photo-labile protecting groups together form a bond and R₃₈ represents hydrogen, C₁₋₄ alkyl which is unsubstituted or substituted with one or more halogen atoms, —OR′, halogen, —NR′R″ or —CO₂R′ wherein R′ and R″ are independently selected from hydrogen and C₁₋₄ alkyl;
R₃₂ represents —OR′, —NR′R″, —O(C₁₋₄alkyl)-COOR′, —O(C₁₋₄alkyl)-OR′ or
—O(C₁₋₄alkyl)-NR′R″, wherein R′ and R″ independently represent hydrogen or C₁₋₄ alkyl; and R₃₁, R₃₃ and R₃₄ are independently selected from hydrogen, halogen, —OR′, —NR′R″, —O(C₁₋₄alkyl)-COOR′, —O(C₁₋₄alkyl)-OR′ or —O(C₁₋₄alkyl)-NR′R″, wherein R′ and
R″ independently represent hydrogen or C₁₋₄alkyl; wherein X represents the link to the remainder of the compound of formula (I); preferably wherein the photo-labile protecting group is selected from:

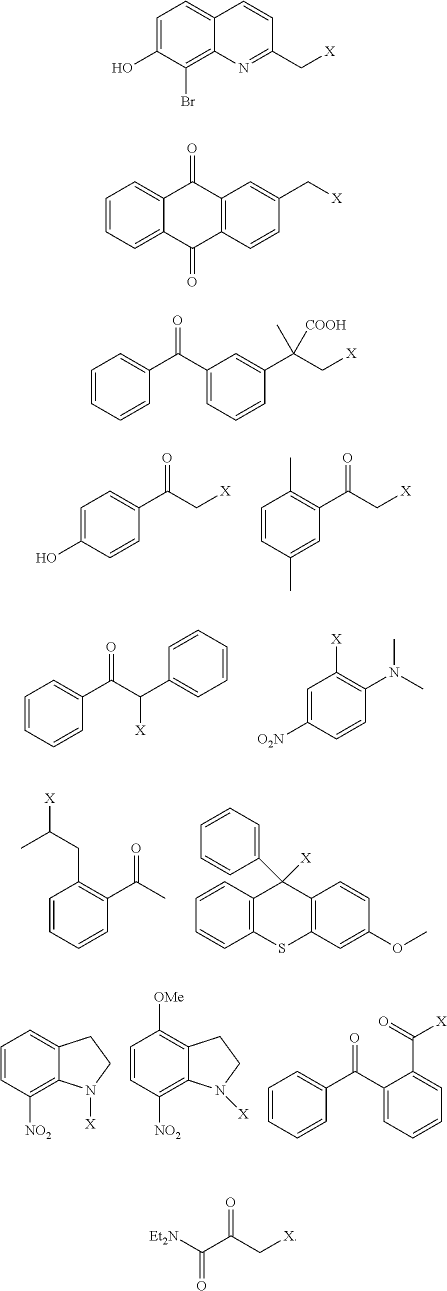

25. The method of claim 16, wherein: (a) the photo-labile protecting group is of formula (IIa): 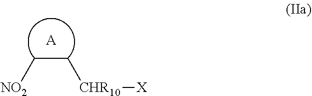
wherein; ring A represents an unsubstituted or substituted group selected from phenyl, naphthyl or dibenzofuranyl, wherein a substituted phenyl, naphthyl or dibenzofuranyl group is a phenyl, naphthyl or dibenzofuranyl group having one or two methoxy substituents, or a phenyl, naphthyl or dibenzofuranyl group wherein two adjacent ring positions are substituted with a —CH₂—O—CH₂-moiety; and R₁₀ represents hydrogen, methyl, —CF3 or —COOH; wherein X represents the link to the remainder of the compound of formula (I) or (b) the photolabile protecting group is of formula (IIIa): 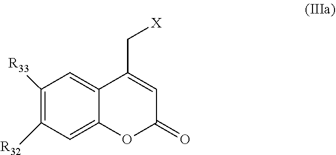
wherein;
R₃₂ represents —OR′, —NR′R″ or —O(C₁₋₄alkyl)-COOR′, wherein R′ and R″ independently represent hydrogen or C₁₋₂ alkyl; and
R₃₃ represents hydrogen, Br, —OR′, —NR′R″ or —O(C₁₋₄alkyl)-COOR′, wherein R′ and R″ independently represent hydrogen or C₁₋₂ alkyl;
wherein X represents the link to the remainder of the compound of formula (I); preferably wherein:
a) R₃₃ represents H and R₃₂ represents OMe, NMe₂, NEt₂ or —OCH₂COOH; or
b) R₃₃ represents Br and R₃₂ represents OH; or
c) R₃₃ and R₃₂ both represent —OCH₂COOH.

26. The method as claimed in claim 16, wherein the method comprises treating the plant in a vegetative growth phase and/or the compound is applied together with at least one fertilizer, fungicide, herbicide, insecticide or plant growth regulator.

27. The method of claim 16, wherein the plant has a greater number of floral buds compared with untreated plants.

28. The method of claim 22, wherein the photo-labile protecting group is of formula (II): 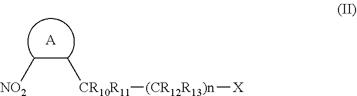
wherein:
(a) ring A represents an aryl or heterocyclic group; or
(b) ring A represents a C₆₋₁₀ aryl group or a 5- to 14-membered heterocyclic group containing one or more atoms selected from N, O and S, wherein the aryl or heterocyclic group is unsubstituted or substituted with one or more substituents selected from C₁₋₄ alkyl, —OR′, halogen, CN, —NR′R″, —COOR′, —(C₁₋₄alkyl)COOR′ and —O(C₁₋₄alkyl)COOR′, wherein R′ and R″ are independently selected from hydrogen and C₁₋₄ alkyl, or wherein two adjacent substituents on the aryl or heterocyclic group together form a 5- or 6-membered heterocyclic ring containing one or more heteroatoms selected from N, O or S; or
(c) ring A represents a phenyl, naphthalenyl or dibenzofuranyl ring;
either (i) R₁₀ and R₁₁ are the same or different and are selected from hydrogen, C₁₋₄ alkyl which is unsubstituted or substituted with one or more halogen atoms, —OR′, halogen, —NR′R″ or —CO₂R′, wherein R′ and R″ are independently selected from hydrogen and C₁₋₄ alkyl, or (ii) two R₁₀ groups on adjacent photo-labile protecting groups together form a bond and R₁₁ represents hydrogen, C₁₋₄alkyl which is unsubstituted or substituted with one or more halogen atoms, —OR′, halogen, —NR′R″ or —CO₂R′, wherein R′ and R″ are independently selected from hydrogen and C₁₋₄ alkyl; n is 0 or 1; and
R₁₂ and R₁₃ are the same or different and are selected from hydrogen, C₁₋₄ alkyl which is unsubstituted or substitute with one or more halogen atoms, —OR′, halogen, —NR′R″ or —CO₂R′, wherein R′ and R″ are independently selected from hydrogen and C₁₋₄ alkyl;
wherein X represents the link to the remainder of the compound of formula (I);
preferably wherein the photo-labile group is selected from: 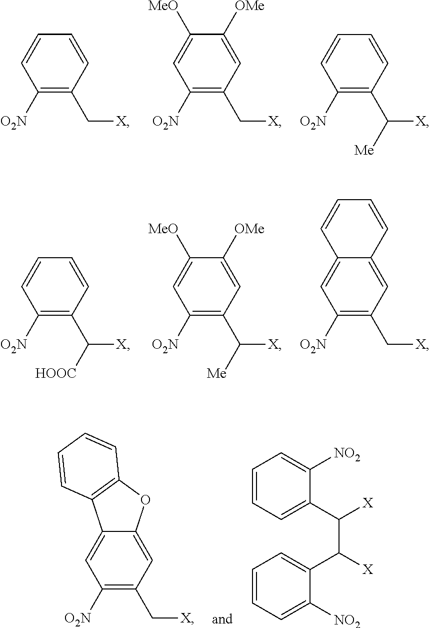
wherein X represents the link to the remainder of the compound of formula (I).

29. The method of claim 22, wherein the photo-labile protecting group is of formula (III): 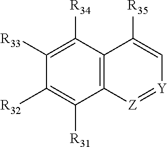
wherein;
either Z represents N, Y represents CR₃₆ and Z and Y are linked by a double bond; or
R₃₆ represents —CR₃₇R₃₈X;
when Y represents CR₃₆, R₃₅ represents hydrogen, and when Y represents C═O, R₃₅ represents —CR₃₇R₃₈X;
either (i) R₃₇ and R₃₈ are the same or different and are selected from hydrogen, C₁₋₄ alkyl which is unsubstituted or substituted with one or more halogen atoms;
—OR′, halogen, —NR′R″ or —CO₂R′, wherein R′ and R″ are independently selected from hydrogen and C₁₋₄ alkyl, or (ii) two R₃₇ groups on adjacent photolabile protecting groups together form a bond and R₃₈ represents hydrogen, C₁₋₄ alkyl which is unsubstituted or substituted with one or more halogen atoms, —OR′, halogen, —NR′R″ or —CO₂R′ wherein R′ and R″ are independently selected from hydrogen and C₁₋₄ alkyl;
R₃₂ represents —OR′, —NR′R″, —O(C₁₋₄alkyl)-COOR′, —O(C₁₋₄alkyl)-OR′ or —O(C₁₋₄alkyl)-NR′R″, wherein R′ and R″ independently represent hydrogen or C₁₋₄ alkyl; and R₃₁, R₃₃ and R₃₄ are independently selected from hydrogen, halogen, —OR′, —NR′R″, —O(C₁₋₄alkyl)-COOR′, —O(C₁₋₄alkyl)-OR′ or —O(C₁₋₄alkyl)-NR′R″, wherein R′ and R″ independently represent hydrogen or C₁₋₄alkyl; wherein X represents the link to the remainder of the compound of formula (I); preferably wherein the photo-labile protecting group is selected from:

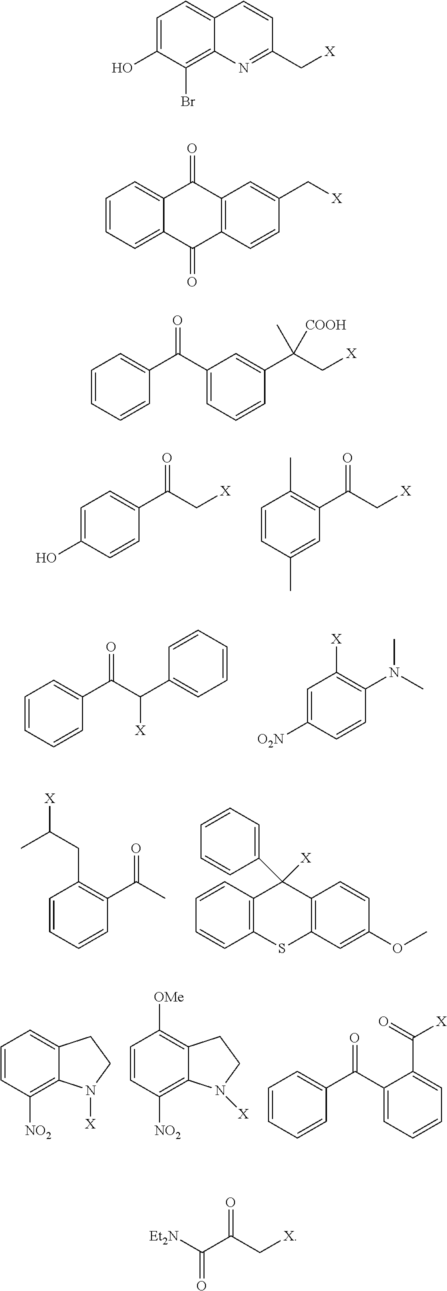

30. The method of claim 22, wherein: (a) the photo-labile protecting group is of formula (IIa): 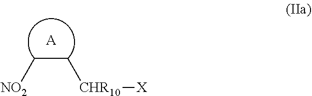
wherein; ring A represents an unsubstituted or substituted group selected from phenyl, naphthyl or dibenzofuranyl, wherein a substituted phenyl, naphthyl or dibenzofuranyl group is a phenyl, naphthyl or dibenzofuranyl group having one or two methoxy substituents, or a phenyl, naphthyl or dibenzofuranyl group wherein two adjacent ring positions are substituted with a —CH₂—O—CH₂-moiety; and R₁₀ represents hydrogen, methyl, —CF3 or —COOH; wherein X represents the link to the remainder of the compound of formula (I); or
(b) the photo-labile protecting group is of formula (IIIa): 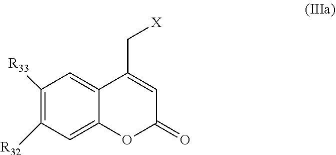
wherein;
R₃₂ represents —OR′, —NR′R″ or —O(C₁₋₄alkyl)-COOR′, wherein R′ and R″ independently represent hydrogen or C₁₋₂ alkyl; and
R₃₃ represents hydrogen, Br, —OR′, —NR′R″ or —O(C₁₋₄alkyl)-COOR′, wherein R′ and R″ independently represent hydrogen or C₁₋₂ alkyl;
wherein X represents the link to the remainder of the compound of formula (I); preferably wherein:
a) R₃₃ represents H and R₃₂ represents OMe, NMe₂, NEt₂ or —OCH₂COOH; or
b) R₃₃ represents Br and R₃₂ represents OH; or
c) R₃₃ and R₃₂ both represent —OCH₂COOH.

31. The method as claimed in claim 22, wherein the method comprises treating the plant in a vegetative growth phase and/or the compound is applied together with at least one fertilizer, fungicide, herbicide, insecticide or plant growth regulator.

32. The method of claim 22, wherein the plant has a greater number of floral buds compared with untreated plants.
